(19) United States
(12) Patent Application Publication
(10) Pub. No.: US 2025/0188336 A1
(43) Pub. Date: Jun. 12, 2025

(54) ENERGY STORAGE

(71) Applicant: VITAL ENERGI SOLUTIONS LIMITED, Blackburn Lancashire (GB)

(72) Inventors: Yulong DING, Edgbaston (GB); Zhu JIANG, Edgbaston (GB); Jie CHEN, Edgbaston (GB); Hongkun MA, Edgbaston (GB)

(21) Appl. No.: 18/843,407

(22) PCT Filed: Mar. 1, 2023
(86) PCT No.: PCT/EP2023/055159

§ 371 Date: Sep. 3, 2024

(30) Foreign Application Priority Data
Mar. 3, 2022 (GB) 2202958.1

(51) Int. Cl. C09K 5/16

(52) U.S. Cl. CPC C09K 5/16

(57) ABSTRACT

A method of forming a composite thermochemical material, the method comprising providing an inorganic host material and providing a hydrated or hydratable inorganic salt, mixing the inorganic host material and hydrated or hydratable inorganic salt to form a mix, allowing or causing at least a portion of the hydrated or hydratable inorganic salt to enter pores and/or void spaces of the inorganic host material and forming the mix into a shaped body.

This invention relates generally to energy storage. More specifically, although not exclusively, this invention relates to thermochemical materials for thermal energy storage.

Worldwide energy consumption is still dominated by fossil fuels. The environmental impacts associated with the use of fossil fuels, such as climate change, has become a significant concern. A number of pathways exist for global energy system decarbonisation and almost all of these routes rely on a deep penetration of renewable generation, which requires energy storage to address the supply-demand mismatch challenges.

Thermochemical energy storage (TCES) is one of three thermal energy storage (TES) technologies for addressing the supply-demand mismatch. The TCES based TES technology is based on reversible thermochemical reactions and/or sorption processes with the energy stored in the form of chemical compounds created by an endothermic process, and recovered when needed by recombining the compounds in an exothermic process. The principle of such a technology can be simply illustrated by the following scheme:
Charging: C+heat→A+B
Storing: A and B stored separately (no or little heat loss)
Discharging: A+B→C+heat
   where A, B and C are reactants or products depending on the charge or discharge processes. Examples of A include hydroxide, hydrate, carbonate and ammoniate; and examples of B include water, CO, ammonia, and hydrogen. C can be in a solid or a liquid form and A and B can be any phase. The amount of heat stored in a TCES system is proportional to the amount of TCES material, the heat of reaction and/or sorption and the extent of the reaction/sorption process. Since the chemical compounds created during charging process can be stored separately, there is no energy loss during storage, and hence the TCES based technology can be used for both long term (weeks to months, and even years) and short term (hours to days) applications as well as for both heating and cooling applications.

At the heart of the TCES based TES technologies are thermochemical materials (TCMs), as which possess a high energy density, allowing a relatively large amount of energy to be stored in a relatively small mass/volume of material.

There are many TCMs and salt hydrates are one category of the materials with numerous potential applications particularly for low and medium temperature ranges. However, salt hydrates in their pure form often face two major technical challenges:
a) They have a low thermal conductivity, leading to the thermochemical process to be heat transfer limited.
b) Almost all of these salts are structurally unstable due to one or more of deliquescence, disintegration, densification, agglomeration and pore/channel blockage after a small number of thermal cycles, leading to the thermochemical process to be mass transfer limited.

Both of the two challenges limit the kinetics of the thermochemical processes; whereas the second challenge leads to poor cyclability and degradation of system performance over time. Both the challenges also make the TCES-based TES less controllable than alternatives.

For example, CaCl₂·6H₂O and LiCl·H₂O are readily deliquescent. These TCMs can only stay form-stable under an very low relative humidity atmosphere, which limits their usable applications.

MgCl₂·6H₂O has a high theoretical energy density (˜3 GJ/m³) and good reaction kinetics, however, structure destablisation often occurs after a few hydration and dehydration cycles, leading to energy density degradation and system clogging. In addition, there are reports of formation of harmful gas, HCl, upon heated to over 130° C.

MgSO₄·7H₂O (Epsomite) has attracted considerable attention in recent decades due to its high theoretical energy density (˜2.8 GJ/m³), low cost and abundance. However, despite considerable efforts, little progress has been made in achieving the high energy density.

The above outlined issues also affect other categories of TCMs. One of the major common challenges preventing the commercialisation of TCES technologies has been material stability, particularly after thermal cycling, and controllability of the kinetics of the charging and discharging processes.

In order to overcome these challenges, efforts have been made to investigate the use of a structural/hosting material to house the TCM. Such a hydrate salt containing material may be termed composite TCM.

The use of a porous matrix has been reported as a support material for TCMs, which provides water vapour transport channels wherein the host matrix acts as a semipermeable container, which retains the salt and allows the passage of water vapour via mechanisms such as diffusion due to concentration gradients and migration due to temperature gradients. This enhances the dehydration/hydration kinetics and conversion, and gives better stability and cyclability, leading to improved performance of the salt hydrate.

In recent years, the use of clay, zeolites, MgO modified zeolite, silica gel, activated carbon, vermiculite, porous glass, and attapulgite have been reported and the impregnation method has been used to insert salt into these hosting material. However, the disclosed matrix materials have a rigid structure, which limits the mechanical stability of the material over thermal cycling due to expansion/contraction of the grains of the salt hydrate during hydration/dehydration. Further, the amount of salt impregnated into the structure is often limited and hence gives a low energy density. Moreover, the cyclability of this type of composite is poor, often below 10 cycles.

Many if not all of the reported preparation methods for composite TCMs are based on impregnation, whereby the porous scaffold material is submerged in a saturated aqueous salt solution, the salt solution permeates the pore structure of the scaffold material and the impregnated matrix is subsequently dried in a furnace set at a certain temperature. However, the impregnation method is energy intensive and the produced composites have a poor mechanical strength and and typically, a low TCM content, leading to a low energy density and poor cyclability. Further, impregnation can take a significant amount of time as it is limited by the pore structure as well as the surface area to volume ratio of the scaffold material.

An alternative approach uses a polymeric macro-porous foam as the porous matrices for salts with reported salt addition up to ˜70%. In this method, the TCM material is mixed with the polymer precursors and the foamed polymer (e.g. silicone foam) formed by the addition of a catalyst. Whilst the foam structure is elastomeric, and so is likely to be capable of withstanding the expansion/contraction forces during cycling regimes, the volumetric energy density of the prepared composite is low, ranging from 0.26 GJ/m³ at 50 wt % TCM to 0.48 GJ/m³ at 70 wt % TCM (Piperopoulos E et al., Appl Sci, 2020, 10). In addition, the preparation process is chemical in nature and requires a catalyst which is disadvantageous and often costly.

It would clearly be advantageous to provide a TCM which has a high energy density (e.g. volumetric and/or mass energy density) and exhibits sufficient mechanical stability to withstand plural operative cycles.

It is therefore an object of the invention to provide a thermochemical material which exhibits one or more of improved material stability, particularly after plural operative cycles, a high energy density, and controllability of the charging and discharging kinetics.

It would also be beneficial to provide a TCM which has low production costs, low energy consumption in the production process, can use abundant materials and/or one which has improved performance compared to other TCMs due to one or both of beneficial heat and mass transfer rates and reaction kinetics.

Accordingly, a first aspect of the invention provides a thermochemical material, the thermochemical material comprising a mixture of particles of an inorganic host material and a hydrated or hydratable inorganic salt.

The inorganic host material may be porous and, advantageously, the porous host material acts as a support material for the provision of intraparticle and interparticle channels for water vapour transport. In such a way, the porous host material can improve the performance of the hydrated or hydratable inorganic salt by providing additional transport channels for mass transfer of reactants, increasing surface area for heat transfer and reaction, and allowing volume change of the salt and hence increased cyclability.

Additionally or alternatively a porous inorganic host material may be sufficiently porous to host at least a portion of the hydrated or hydratable inorganic salt in the pores thereof, thus enabling the material to have a high energy storage density.

The thermochemical material may be in a pellet, tablet, granule or extruded form.

The hydrated or hydratable inorganic salt may be a hygroscopic salt e.g. CaCl₂, MgCl₂, MgSO₄, SrBr₂. For example, the hydrated or hydratable inorganic salt may be selected from MgSO₄·7H₂O, K₂CO₃·H₂O, CaSO₄·2H₂O or SrBr₂·6H₂O or mixtures thereof. Additionally or alternatively, the hydrated or hydratable inorganic salt may be selected from aluminium sulphate (e.g. Al₂(SO₄)₃·6H₂O), copper sulphate (e.g. CuSO₄·5H₂O), lithium sulphate (e.g. Li₂SO₄·H₂O), calcium hydroxide (Ca(OH)₂), magnesium hydroxide (Mg(OH)₂·H₂O), iron oxide (e.g. Fe(OH)), sodium sulphide (e.g. Na₂S·5H₂O) and mixtures of one or more of the same, either with or without one or more of the above-mentioned hygroscopic salts.

Advantageously, the inorganic host material, not only provides the structure to hold the hydrated or hydratable inorganic salt, prevent their leakage and enhance the mechanical strength and thermal cyclability, but also improves the dehydration and rehydration kinetics and hence the overall material performance, compared with the pure salt hydrate.

The hydrated or hydratable inorganic salt may have a volumetric energy density above 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1 or 3.2 GJ/m³. The hydrated or hydratable inorganic salt may have a volumetric energy density in the range 0.9-3.2 GJ/m³, preferably above 1.0, 1.1, 1.2, 1.3, 1.4, 1.5, 1.6, 1.7, 1.8, 1.9, 2.0, 2.1, 2.2 to 3.2 GJ/m³.

The hydrated or hydratable inorganic salt may be selected based on one or more of theoretical energy density, temperatures of hydration and dehydration, chemical stability, corrosiveness and/or toxicity, end use requirements, abundance and cost.

The hydrated or hydratable inorganic salt may be particles, for examples particles in the nanoparticle, submicron and micron ranges. Preferably, the inorganic host material is porous and at least some of the hydrated or hydratable inorganic salt, for example particles of the hydrated or hydratable inorganic salt, is/are provided within the pores of the inorganic host material, and some of the salt particles are in voids between inorganic host materials. Thus the salt particles may be located intra particle and/or interparticle of the host material. In embodiments, the inorganic host material may form agglomerates of primary particles and the hydrated or hydratable salt material may be located within pores or void spaces as of the agglomerates.

The hydrated or hydratable inorganic salt may be present in mass percentages above 10 wt %, say above 15, 20, 25, 30, 35, 40, 45, 50, 55, 60, 65, 70, 75, 80 wt % of the composite thermochemical material. For example, the hydrated or hydratable inorganic salt may be present in mass percentages of 10 to 60 wt % of the thermochemical material, e.g. 10, 15, 20, 25, 30, 35, 50, 45, 50, 55 or 60 wt % salt hydrate, for example and one of 10, 15, 20, 25, 30, 35, 40, 45, 50, 55 wt % to any one of 80, 75, 70, 60, 55, 50, 45, 40, 35, 30, 25, 20, 15 wt %.

The inorganic host material may be selected from for example vermiculite, zeolites, MgO, diatomite, clay, silica gel, porous glass, attapulgite, graphite, activated carbon, and/or combinations thereof. Advantageously, the inorganic host materials are cheap and possess or can be fabricated with excellent pore structures.

The thermochemical material may comprise inorganic host material in the range of less than 90 wt %, e.g. less than 85, 80, 75, 70, 65, 60, 55, 50, 45, 40, 35, 30, 25, 20 wt %. The inorganic host material may be present in the range of 20 to 90 wt % e.g. 20, 25, 30, 35, 40, 45, 50, 55, 60, 65, 70, 75, 80, 85 or 90 wt %.

Preferably the inorganic host material is present as a minor (wt %) component of the thermochemical material. Preferably the hydrated or hydratable salt is present as a major (wt %) component of the thermochemical material.

The particles of the inorganic host material may have a particle size in the range of 0.01 to 10 mm, for example from 0.02, 0.03, 0.4 or 0.05 to 10.0 9.0, 8.0, 7.0, 6.0, 5.0, 4.0, 3.0, 2.0, 1.0 mm. The particles of inorganic host material may have a particle size in the range 0.08 mm to 1 mm.

The thermochemical material may further comprise a binder. Advantageously, the addition of binder may help the formation of shape-stable forms. Further, the addition of a binder may enhance the mechanical strength of the thermochemical material over charging/discharging cycles.

The binder may be a high temperature/hygroscopic polymer binder. The binder may be as selected from one or more of Polyvinylpyrrolidone (polyvidone PVP), starches, alginates, casein, cellulose adhesives, for example hydroxypropyl methylcellulose (HPMC), polyvinyl acetate (PVA), polyacrylic acid and the like. The binder may preferably be a water-soluble hygroscopic polymer.

If the binder is hygroscopic it may help the thermochemical material attract and hold/store more water molecules (for facilitating the thermochemical process), therefore providing water buffering and balancing functions during thermochemical reaction/sorption processes.

Advantageously, the addition of binder has been shown to enhance the TCM performance whilst giving little influence on the thermophysical properties of the thermochemical material.

The percentage of binder may be in the range up to 5 wt %, for example between 0.25 to 5 wt % of the thermochemical material, e.g. 0.5 to 3 wt %. For example, the mass percentage of binder may be 0.25, 0.5, 0.75, 1.0, 1.25 1.5, 1.75, 2, 2.25, 2.5, 2.75, 3, 3.25, 3.5, 3.75, 4, 4.25, 4.5, 4.75 or 5 wt %. In embodiments the binder may be presented as a solution. In cases where a binder solution is used, the above-identified weight percentage of binder relates to the binder per se, rather than the binder solution.

The hydrated or hydratable salt may have a stoichiometry in which plural water molecules hydrate the salt molecule. The dehydration reaction of the hydrated or hydratable salt may occur in a stepwise manner.

The formulation may further comprise a flow aid for enhancing the mixing and reducing caking/agglomeration of the salt and host material particles. The flow aid may be a fumed silica, for example a fumed silica selected from from AEROSIL® fumed silica (available from Lawrence Industries Ltd of Tamworth UK) and SIPERNAT® precipitated silica (available from Evonik Industries AG or Essen Germany). The weight percentage of flow aid may be between 0.01% to 5.0%.

The operating temperature, e.g. reaction temperature, of the thermochemical material, may be from 20 to 500° C. In an embodiment the operating temperature may be at or below 200, 175 or 150° C., e.g. at or below 145, 140, 145, 130, 135, 120, 125 or 120° C. For example, the operating/reaction temperature may be 150, 149, 148, 147, 146, 145, 143, 142, 141, 140, 139, 138, 137, 136, 135, 134, 133, 132, 131, 130, 129, 128, 127, 126, 125, 124, 123, 122, 121, 120, 119, 118, 117, 116 or 115° C. This is advantageous as 150° C. is known as a reachable temperature by a solar thermal collector and also within the range of industrial waste heat temperature.

The volumetric energy density based on the reaction enthalpy of the thermochemical materials, may be in the range 80 to 2000 MJ/m³, e.g. 90 to 800, or 100 to 2000 MJ/m³, e.g. 103 MJ/m³ to 2000 MJ/m³. The heat of reaction may increase with decreasing pore size of the inorganic host material.

The mass energy density of thermochemical material may be in the range 400 to 1500 J/g, e.g. 600 to 1400 J/g, 600 to 1000 J/g, 650 to 900 J/g, or 658 to 758 J/g.

Advantageously, the method of the invention may enable the thermochemical material to reach an energy density of >˜1000 kJ/g (>˜1 GJ/m³ or 280 KWh/m³).

Advantageously, the thermochanical material is non-toxic.

The thermochanical material may be used to store industry waste heat and/or renewable heat from solar and/or wind for building applications, e.g. space heating, cooling, hot water supply, hot air supply, and/or steam supply.

The thermochanical material may be used for next generation air-conditioning systems, partially replacing refrigerant based vapour compression technologies.

Accordingly, a second aspect of the invention provides a method of manufacturing a thermochanical material, the method comprising:
a) Mixing, preferably dry mixing, a salt hydrate and an inorganic host material; and
b) shaping/compacting the dry powder mixture to a shape-stable body, the composite TCM body may be in the form of a pellet, granule or extrudate.

A further aspect of the invention provides a method of forming a composite thermochanical material, the method comprising providing an inorganic host material and providing a hydrated or hydratable inorganic salt, mixing the inorganic host material and hydrated or hydratable inorganic salt to form a mix under low relative humidity conditions, allowing or causing at least a portion of the hydrated or hydratable inorganic salt to enter pores of the inorganic host material and forming the mix into a shaped body.

Advantageously, dry mixing (i.e. under relatively low humidity conditions) overcomes the issues associated with wet processes, such as corrosion, waste streams and high energy consumption due to drying. In this specification, relatively low humidity conditions means ambient conditions or conditions below which the hydrated or hydratable inorganic salt will dilequesce.

Advantageously, the method does not require a washing phase, i.e. it is not required to wash through the materials after mixing. Instead, the salt hydrate is compacted with the inorganic host material as a formulation of the TCM composite.

Step (a) may comprise adding salt hydrate in ratios of 10 to 80 wt %, e.g. 10, 15, 20, 25, 30, 35, 50, 45, 50, 55, 60, 65, 70, 75 or 80 wt % salt hydrate. The salt hydrate may be a hygroscopic salt e.g. CaCl₂, MgCl₂, MgSO₄, SrBr₂, in a dehydrated form. The salt hydrate may be MgSO₄·7H₂O, KCO₃·1.5H₂O, CaSO₄·2H₂O or SrBr₂·H₂O in their hydrated form.

Step (a) may comprise adding inorganic host material in the range 20 to 90 wt % e.g. 20, 25, 30, 35, 40, 45, 50, 55, 60, 65, 70, 75, 80, 85 or 90 wt % host material. The host material may be porous at individual particle scale e.g. vermiculite, zeolites, and diatomite; non-porous at particle scale e.g. some MgO and graphite; and/or combinations thereof. The inorganic host material is in powder form, with the pores of porous host material consisting of both interparticle (between particles) and intraparticle pores (inside individual particles), whereas that of non-porous host material containing only interparticle pores. The porous host material may have a median pore size/diameter in the range 7 nm to 500 μm.

The method may comprise pre-milling the inorganic host material, e.g. using a shred-mill, pin mill and/or a ball mill, prior to step (a). Pre-milling the inorganic host material may achieve an optimal size of the porous host material in the range 0.01 to 1.5 mm, e.g. 0.02, 0.05, 0.09, 0.12, 0.25, 0.5, 0.75, 1.00, 1.5 mm, or a mixture of different sizes.

For low- and non-moisture-sensitive formulations, the method may comprise grinding the mixture from step (a) into small particles, e.g. micro particles, e.g. in the range 7 nm to 500 μm. In such a way, salt grains may be reduced to small particle sizes (e.g. 5 nm to 500 μm) for fitting into the interparticle and intraparticle pores of the porous host material.

The method may comprise diffusing the salt hydrate into the structure of the hosting material, e.g. under deliquescence conditions.

Step (b) may occur through two major processes, a batch process and a continuous process.

The batch process may use a compaction device e.g. tabletting machine, granulator, hydraulic press, or briquette maker. A small amount of water may be added to assist with the shape-stablisation and lubrication. The percentage of the water addition ranges from 0 to 8% by mass, e.g. 0.1, 0.5, 1, 1.5, 2, 2.5, 3, 4, 5, 7, 8%.

The continuous process uses an extrusion device, e.g. single screw extrusion machine, or twin extrusion machine.

Step (b) may comprise heating to a temperature of less than 150° C., e.g. less than 145, 140, 135, 130, 125, 130, 125, 120, 115, 110, 105, 100, 95, 90, 85 or 80° C., to dry the composite TCM body.

The method may further comprise adding a binder, e.g. a high temperature/hygroscopic polymer binder. The binder may be Polyvinylpyrrolidone (polyvidone PVP), a water soluble hygroscopic polymer with good binding properties. The addition of binder may involve (i) dissolving the binder in water, e.g. 1 to 15 wt % of solution and (ii) adding a small amount of binder solution, e.g. 0.1 to 5 wt % with respect to the TCM composite, to the mixture in Step (a).

The method may further comprise adding a flow aid to the mixture in Step (a). The flow aid may be selected from from AEROSIL® fumed silica and SIPERNAT® precipitated silica. The percentage of flow aid may be between 0.01% to 5.0%.

The batch process using tableting device in Step (b) may comprise employing a compression loading speed of between 30 mm/min and 5 mm/min, e.g. between 20 mm/min and 10 mm/min, e.g. 30, 25, 20, 15, 10 or 5 mm/min. Compression of the mixture, may comprise employing a stress holding time of between 0.5 and 5 minutes, e.g. between 1 and 3 minutes, e.g. 0.5, 1, 1.5, 2, 2.5, 3, 3.5, 4, 4.5 or 5 minutes. Compression of the mixture, may comprise employing a pressure of between 1 and 100 MPa, e.g. 1, 5, 10, 15, 20, 25, 30, 35, 40, 45, 50, 55, 60, 65, 70, 75, 80, 85, 90, or 100 MPa.

The structural stabilisation of the composite TCM body, may be improved by using a slow loading speed and a long stress/pressure holding time during compression.

The method may further comprise granulating the mixture of host material and the salt hydrate before or in Step (b). The granules produced in Step (b) may be used as one of TCM body forms.

Advantageously, the method of the invention may enable the thermochanical material, to reach an energy density >˜1000 kJ/g (>˜1 GJ/m³ or 280 KWh/m³).

Advantageously, the manufacturing methods of the invention enables the customisation of the shape and/or size of the thermochanical material modules with a strong mechanical strength and a good stability; and are easy to scale up.

Advantageously, the method of the invention forms thermochanical material bodies, which have substantially increased mechanical strength, reduced volumetric change, reduced caking and leakage, improved hydration/dehydration kinetics and much improved thermal stability and cyclability, compared to the prior art.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

The invention will now be described, by way of example only, and with reference to the accompanying drawings in which:

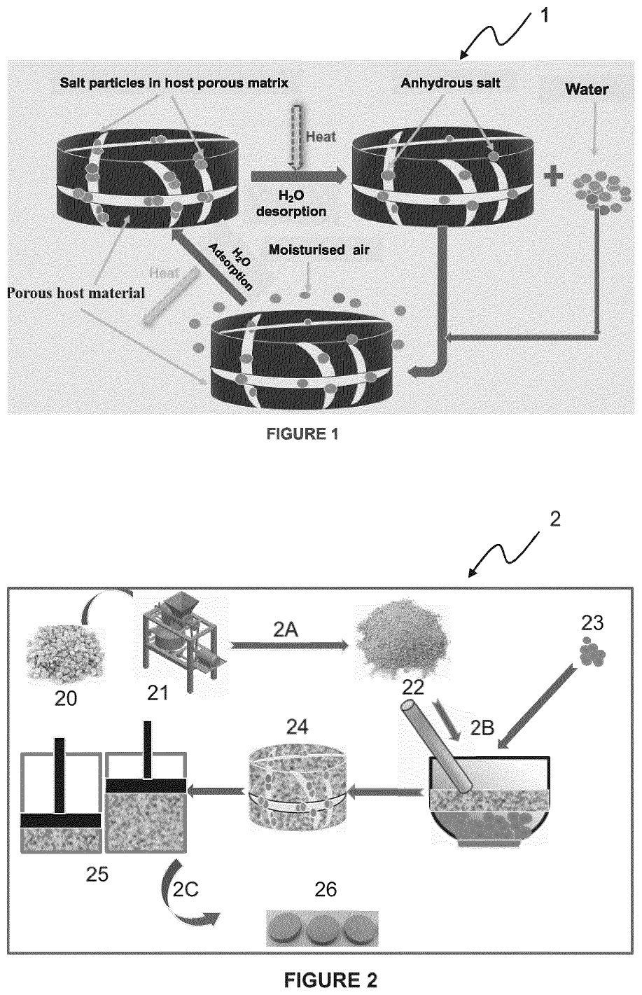

FIG. 1 is a schematic showing the working principle of thermochemical energy storage using composite thermochemical material module;

FIG. 2 is a schematic illustration of composite MgSO₄·7H₂O body manufacturing method using a batch compaction process;

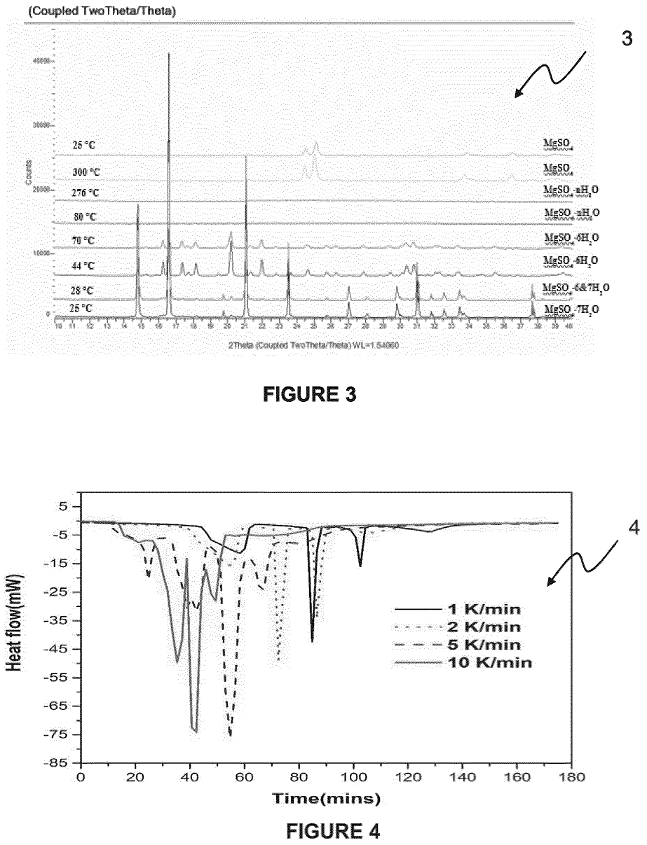

FIG. 3 is a graph showing the X-Ray Diffraction (XRD) curves of MgSO₄·7H₂O dehydration at different temperatures;

FIG. 4 is a graph showing the Differential Scanning Calorimetry (DSC) curves of MgSO₄·7H₂O dehydration at different heating rates;

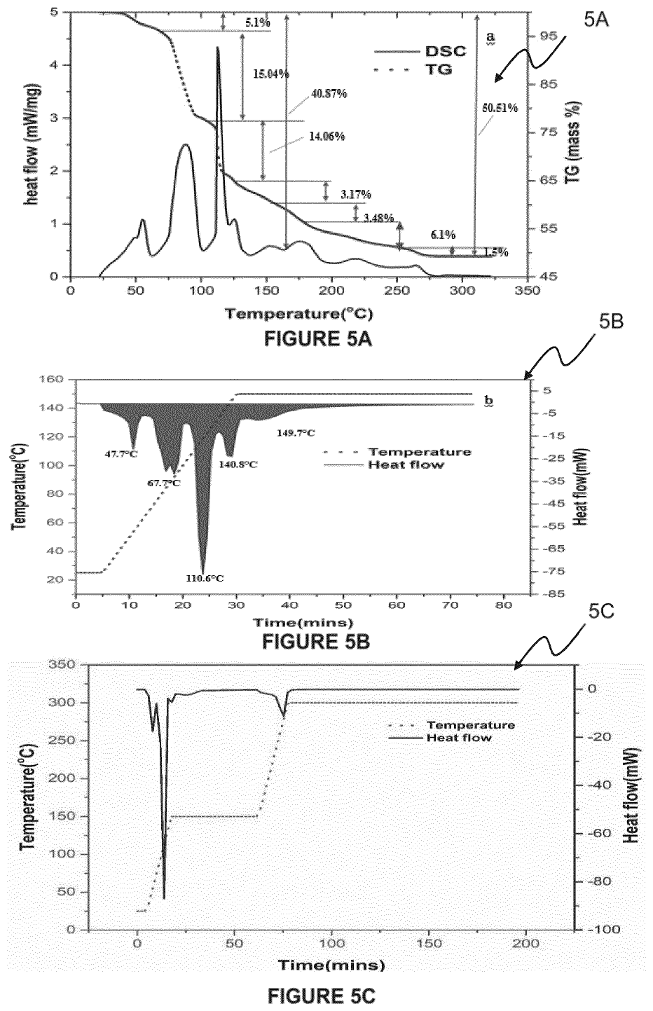

FIGS. 5A to 5C show the simultaneous thermal analysis (STA) and DSC measurement results of dehydration of MgSO₄·7H₂O;

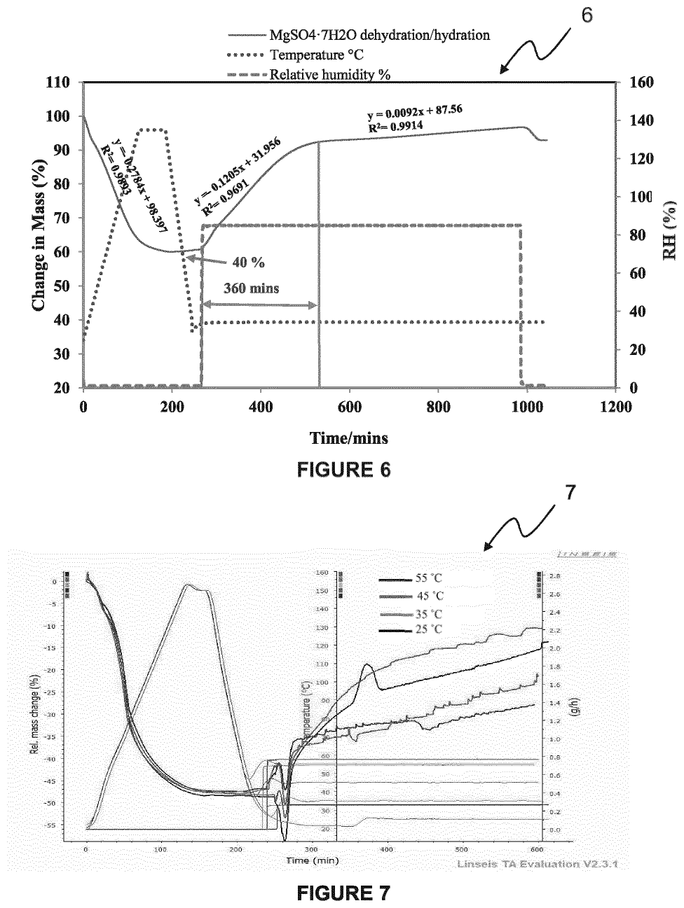

FIG. 6 is a graph showing a desorption process followed by an adsorption process of MgSO₄·7H₂O;

FIG. 7 is a graph showing the effect of temperature on dehydration and hydration of MgSO₄·7H₂O;

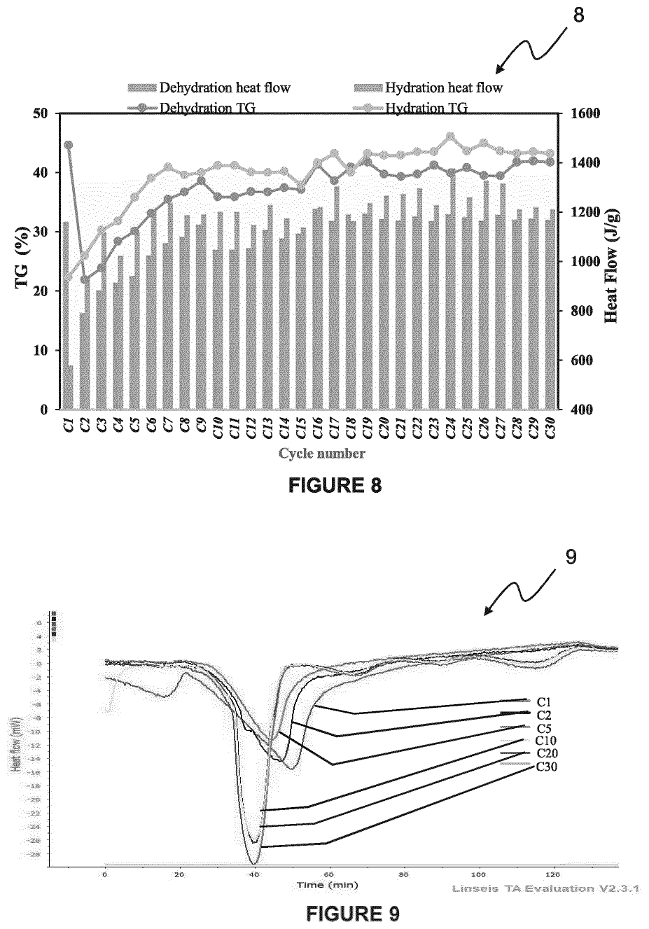

FIG. 8 is a graph showing the behaviour of MgSO₄·7H₂O dehydration/hydration over 30 thermal cycles;

FIG. 9 is a graph showing MgSO₄·7H₂O dehydration profile after different cycles;

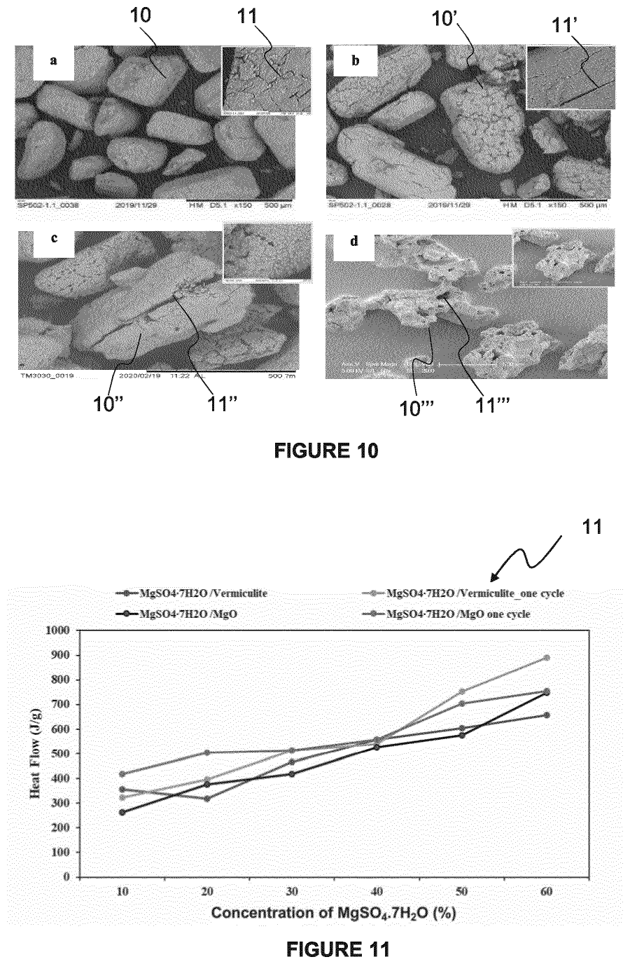

FIGS. 10A to 10D are Scanning Electron Microscopy (SEM) images showing the salt crystal shape and morphology of MgSO₄·7H₂O after various thermal cycles;

FIG. 11 is a graph showing the DSC heat flow data during dehydration of different MgSO₄·7H₂O composites;

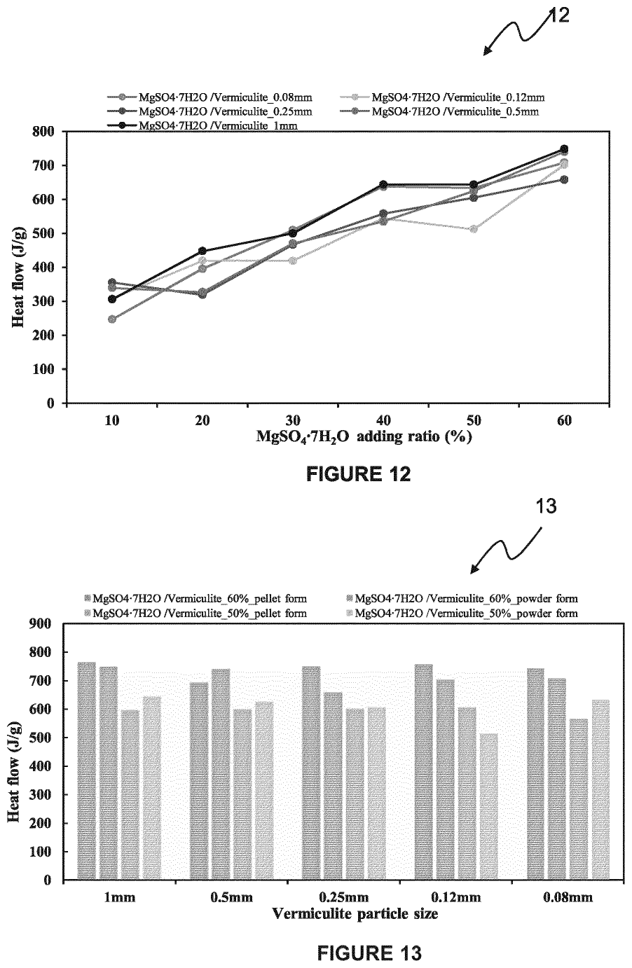

FIG. 12 is a graph showing the effect of particle size of the hosting material on measured heat flow during dehydration of MgSO₄·7H₂O composite;

FIG. 13 is a graph showing the DSC heat flow of MgSO₄·7H₂O/vermiculite composites in pellet and powder forms measured under dehydration;

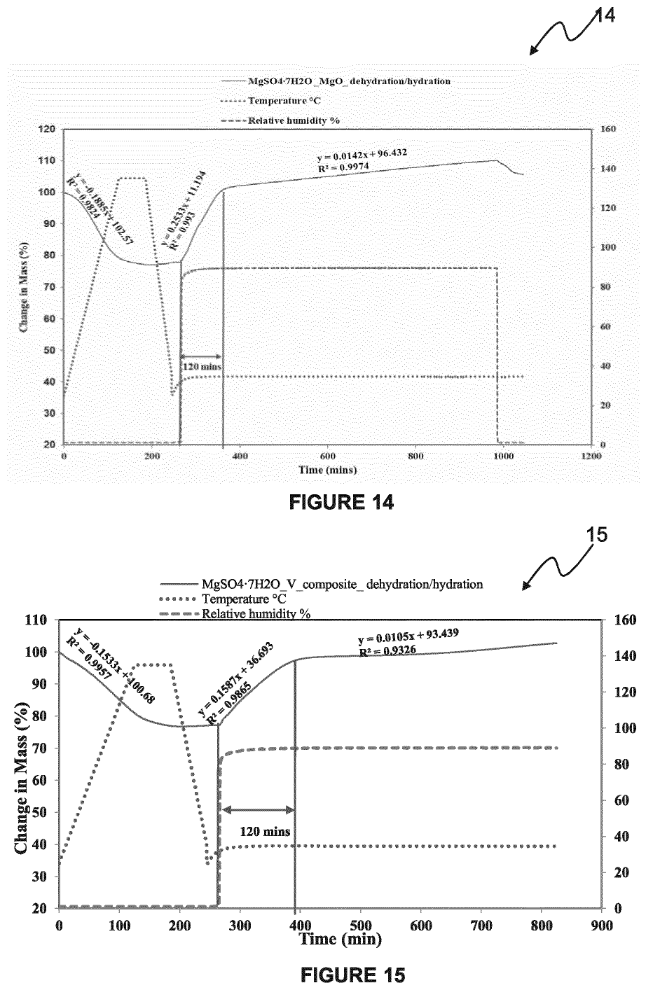

FIG. 14 is a graph showing the Dynamic Vapour Sorption (DVS) measurement result of desorption (dehydration) and adsorption (hydration) processes of MgSO₄·7H₂O/MgO composite;

FIG. 15 is a graph showing the (DVS) measurement result of desorption (dehydration) and adsorption (hydration) processes of MgSO₄·7H₂O/vermiculite composite over one cycle;

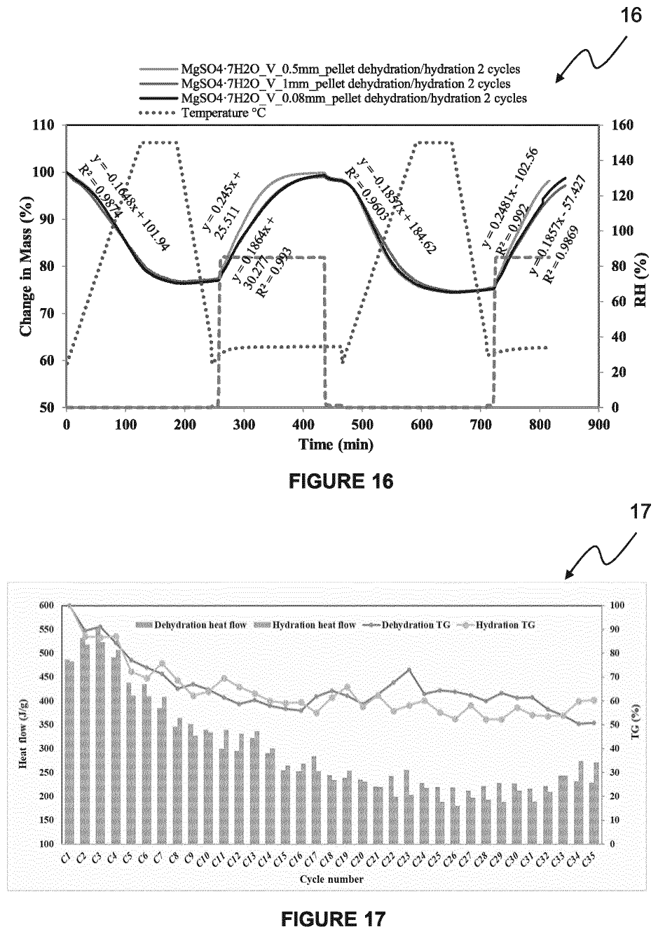

FIG. 16 is a graph showing the effect of particle size of vermiculite on hydration and dehydration of MgSO₄·7H₂O/vermiculite composites over two cycles;

FIG. 17 is a graph showing the heat flow (DSC measurements) and mass change (TG measurements) of the dehydration and hydration processes over 35 cycles for the 60 wt % MgSO₄·7H₂O/MgO composite;

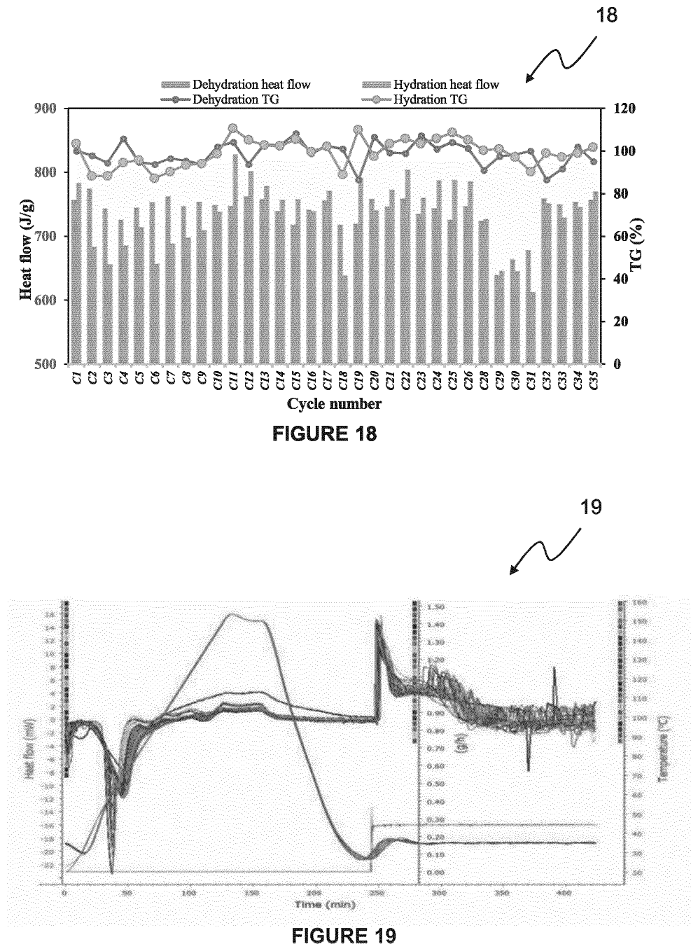

FIG. 18 is a graph of the heat flow (DSC measurements) and mass change (TG measurements) of the dehydration and hydration processes over 35 cycles for the MgSO₄·7H₂O/vermiculite composite;

FIG. 19 is a graph showing DSC curves of 60 wt % MgSO₄·7H₂O/0.5 mm vermiculite composite after various cycles;

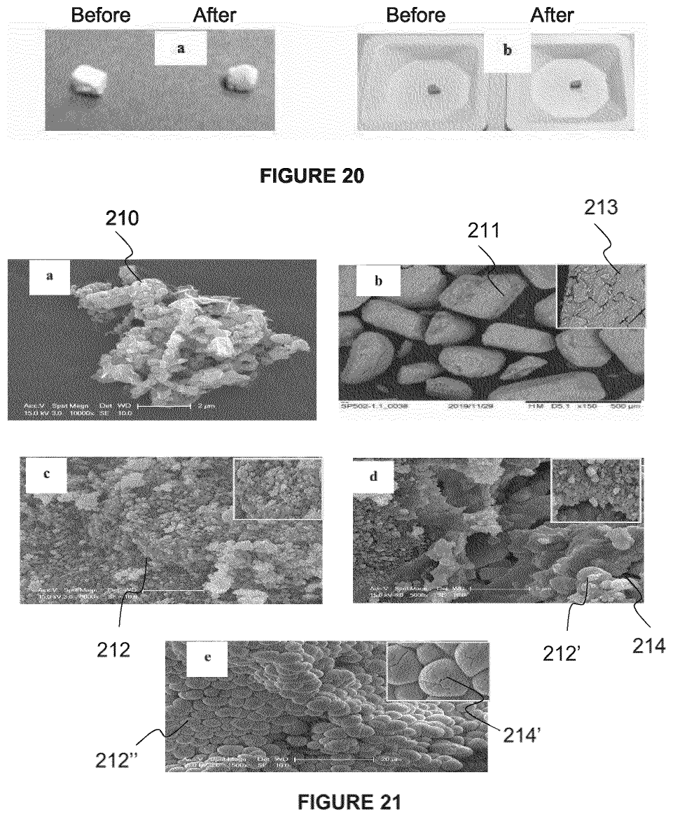

FIGS. 20A and 20B are images of MgSO₄·7H₂O composites before and after STA cycling;

FIGS. 21A to 21E are SEM images of MgSO₄·7H₂O/MgO composites before and after thermal cycling in a STA;

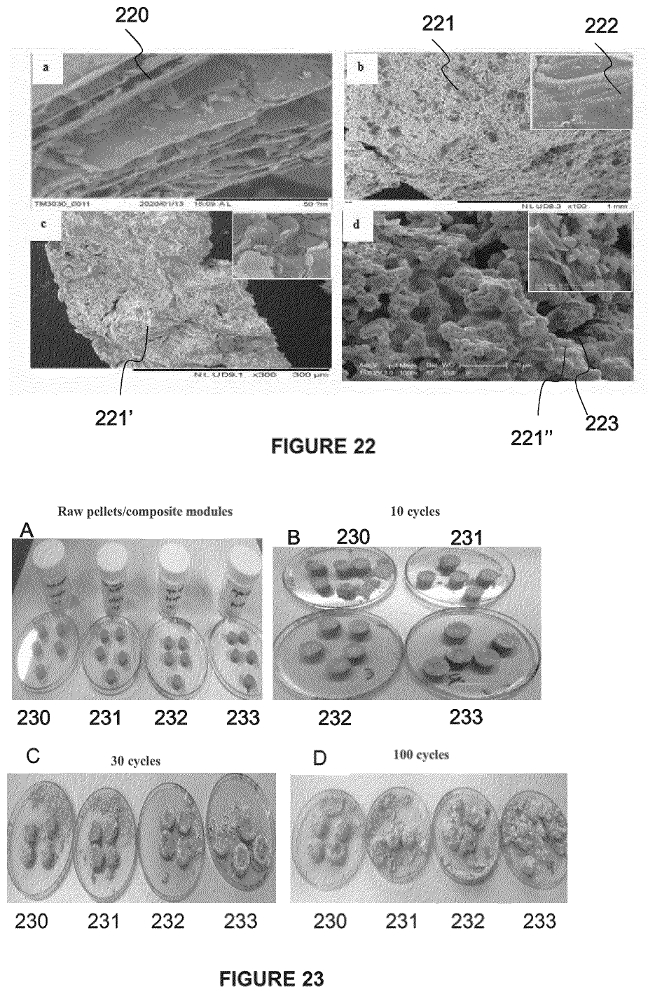

FIGS. 22A to 22D are SEM images of MgSO₄·7H₂O/vermiculite composites before and after thermal cycling in a STA;

FIGS. 23A to 23D are images of 60 wt % MgSO₄·7H₂O/0.5 mm vermiculite composite pellets after various cycles in a humidity chamber;

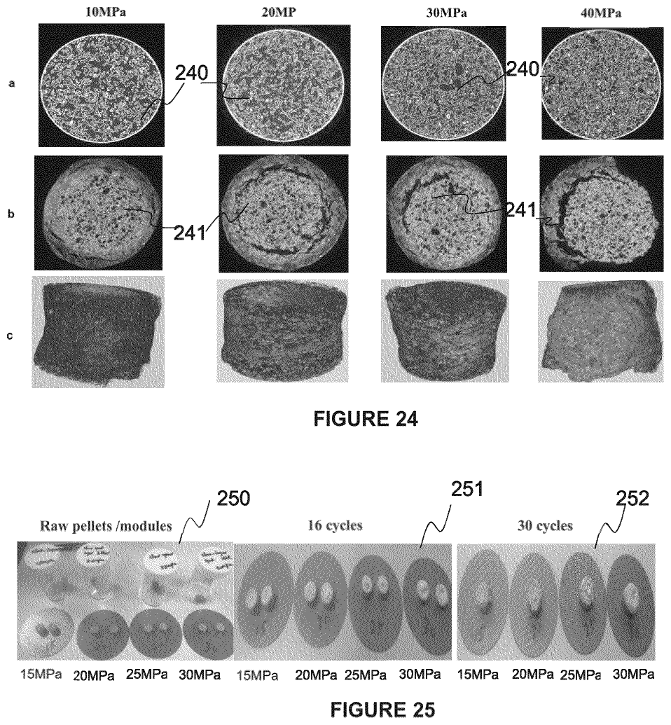

FIGS. 24A to 24C are X-Ray Tomography (XRT) images of 60 wt % MgSO₄·7H₂O/vermiculite composite pellets made with various compression pressures after 10 cycles in a humidity chamber;

FIG. 25 shows images of 60 wt % MgSO₄·7H₂O/vermiculite pellets after various cycles in a humidity chamber;

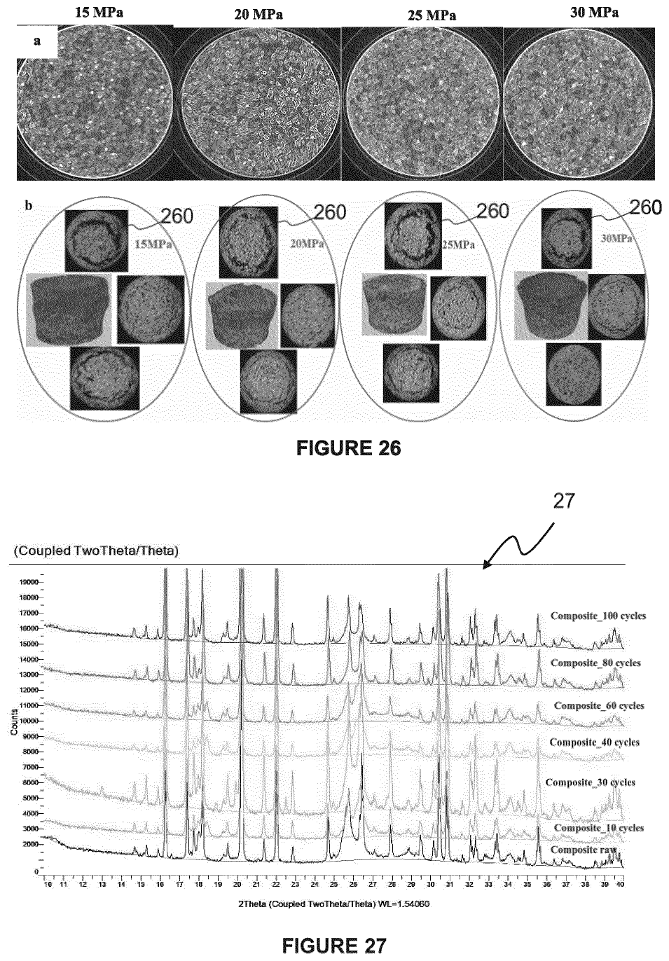

FIGS. 26A and 26 B are XRT images of 60 wt % MgSO₄·7H₂O/vermiculite pellets after 16 cycles in a humidity chamber;

FIG. 27 is a graph of the XRD curves of 60 wt % MgSO₄·7H₂O/vermiculite pellets after various cycles in a humidity chamber;

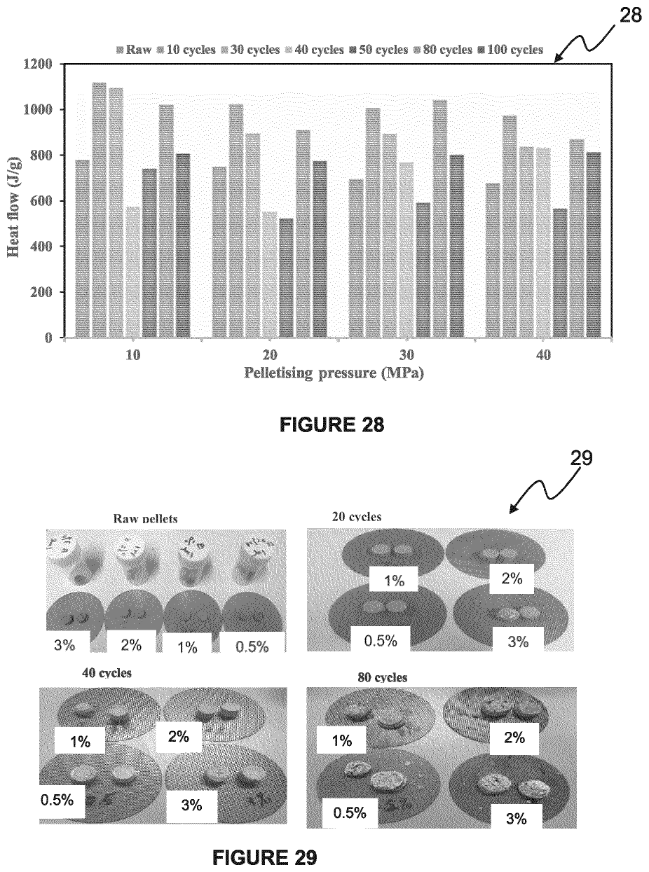

FIG. 28 is a graph of the DSC heat flow measurement data of 60 wt % MgSO₄·7H₂O/vermiculite pellets after various cycles in a humidity chamber;

FIG. 29 is an image of 60 wt % MgSO₄·7H₂O/vermiculite composite with 0.5-3 wt % PVP after various cycles in a humidity chamber showing 2% being optimal; and

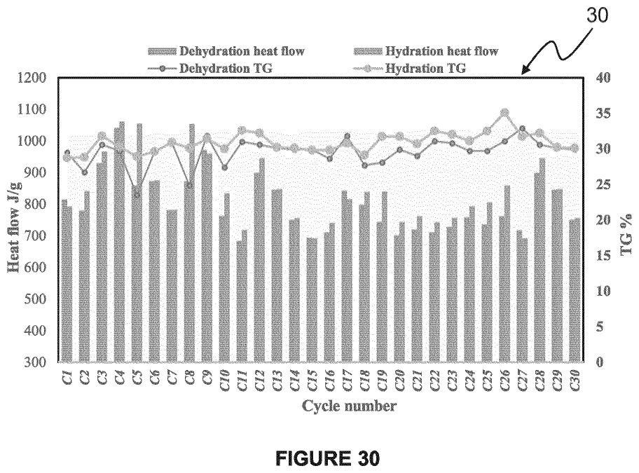

FIG. 30 is a graph of the dehydration/hydration and cycling behaviour of MgSO₄·7H₂O/vermiculite composite with 2 wt % PVP binder.

A schematic 1 of a salt hydrate composite working principle during the processes of dehydration (desorption) and hydration (adsorption) is illustrated in FIG. 1. A porous matrix (e.g. vermiculite, zeolites, MgO etc.) hosts a hygroscopic salt (e.g. CaCl₂, MgCl₂, MgSO₄, SrBr₂, etc.) in order to provide extended surface and sites to the dehydration/hydration reaction, to limit the effect of deliquescence of the salt, to provide channels for mass transfer, and to enhance mechanical properties and heat transfer.

Heat is stored in the desorption (dehydration) process by breaking the binding force between the sorbent (salt hydrates) and the sorbate (water). In this process, the salt hydrate is converted to partially dehydrated salt or anhydrous salt and the water is condensed (with heat of condensation recovered). The salt and water may be stored separately at ambient temperature with almost no energy loss. The matrix serves to hold the sorbent, prevent leakage, enhance heat and mass transfer, and enhance reaction kinetics and mechanical properties. Heat is released on demand through the sorption (hydration) process when the charged composite is exposed to a moisturized air leading to an exothermic reaction. The above dehydration and hydration processes are repeated to store and release heat in a cyclic manner. By using this principle, renewable energy such as solar, wind and biomass, industrial waste heat and off-peak electricity can be converted and stored when supply exceeds demand, for use when demand exceeds supply e.g. meeting the peak heating demand in winter and peak cooling demand in summer. The storage process can be long term (months and years) due to almost zero loss during storage, which can also meet the short (hours) and medium term (days and weeks) needs.

In the following, the experimental procedures and characterisation methods are explained, using MgSO₄·7H₂O as an example salt, and MgO and vermiculite as example hosting materials:

### Experimental

### 1. Raw Materials

Reagent grade powders of magnesium sulphate heptahydrate (VWR, CAS 10034-99-8, 99.5% pure) with particle size ranging from 0.2 mm to 0.5 mm, magnesium oxide (Merck, CAS 1309-48-4, ≥99% pure) with particle size ranging from 5 μm to 10 μm, and vermiculite (Merck, CAS 1318-00-9) with particle size ranging from 2 mm to 10 mm were used. The coarse vermiculite materials were crushed prior to the experiments to obtain particles with different sizes ranging from 0.08 mm to 1 mm.

### 2. Composite TCM Formation and Manufacturing

Referring to FIG. 2, there is shown a flow chart 2 for the formulation and manufacturing of the composite material using a batchwise compaction process. The steps are as follows:
a) inorganic host material 20, such as vermiculite, is crushed to fine powder 22 of various particle sizes, typically between 80 μm and 1 mm, using a shred or an alternative mill 21, (Step 2A);
b) a preset amount e.g. 5-10 g of thermochemical material 24 is prepared by adding, for example MgSO₄·7H₂O 23 (for example at mass percentages of from 10 to 80 wt %) into the host material powder 22 and dry mixing the two materials 22, 23 (Step 2B) by using a mixer. At laboratory scales this can be achieved using a a motar. The act of mixing or grinding causes the thermochemical material to fracture into smaller particles, at least some of which will enter pores in the host material powder;
c) the mixture 24 is shaped to form composite TCM modules or pellets 26, e.g. 13 mm diameter disc-like modules under lab conditions, using a compression machine 25 under various pressures, for example 20 MPa, (Step 2C); and
d) the composite TCM modules/pellets 26 are stored in sealed containers e.g. glass vessels.

### 3. Material Characterisation

### X-Ray Diffraction (XRD)

XRD measurements were carried out to identify the variations in crystallinity and phase during MgSO₄·7H₂O dehydration process at temperatures ranging from 25° C. to 300° C. The XRD patterns were collected by a Bruker D8 Advance with an in-situ high temperature stage using kV, 40 mA and Cu Kα1+Kα2 radiation source. The scans were recorded in the 28 range between 10 and 40° using a step size of 0.02° at a scan speed of 0.2 s/step. The sample was heated slowly from 25° C. to 300° C. at a heating rate of 1° C./min to avoid the measured peaks shifting to higher temperatures, and then quickly cooled down from 300° C. to 25° C. at a cooling rate of 12° C./min. The diffraction patterns were recorded every 10° C. in the heating mode.

The experimental raw patterns were analysed using the Bruker EVA evaluation software with the JCPDS-ICDD PDF 2016 database.

### Scanning Electron Microscopy (SEM)

SEM measurements were performed to identify the change and variations in the morphology of MgSO₄ hydrates after cyclic dehydration and hydration. The morphology of the samples was obtained by using a Hitch TM3030 desktop SEM at 15 kV.

### X-Ray Tomography Micro CT (XRT)

XRT measurements were conducted with a Bruker Skyscan 2211 with a CMOS flat-panel detector to study the internal structures of the MgSO₄ composites after dehydration and hydration cycles. The XRT scans were carried out using an accelerating voltage of 180 kVp, 120 uA current with Cu filter under an exposure time of 250 ms. The images were recorded by using a rotation step of 0.2°/second. Images acquired from different angles allowed the reconstruction of 2D and 3D structure of the composites with the Bruker XRT reconstruction processing software.

### Mercury Porosimetry

Mercury intrusion porosimetry was used to characterize the porosity of the porous vermiculites, MgO and salt composites. Data were collected using an Autopore IV 9500 porosimeter (Micrometrics GmbH, Germany), which allowed the measurement of a pore diameter ranging from 0.003 to 360 μm. The analyses were typically performed with 50 μmHg evacuation pressure, 5 min evacuation time, 0.49 psia mercury filling pressure, and 5 sec equilibration time for both low pressure and high pressure pots. Additional physisorption measurements were carried out to determine surface area and volume of pores with diameters <13 nm (the lower limit of the Hg porosimeter measurements) with nitrogen adsorption at 196° C. on a Micromeritics TriStar II Plus after pre-treatment under vacuum for 2 h at a temperature of 150° C. The surface area was calculated using the BET method based on the adsorption data in a partial pressure range of 0.02-0.20 p/p₀. Pore size analyses were performed using the Barrett-Joyner-Halenda approach.

### 4. Analyses of Dehydration/Hydration Kinetics and Cyclability

Thermal analyses were conducted to understand the dehydration and hydration kinetics and cyclability of the TCM. Three thermal analysis techniques of DSC, STA, STA with a pressure and humidity control unit, and a sorption analysis technique of DVS were used:

### Differential Scanning Calorimetry (DSC)

DSC measures heat flow changes (heat absorption or heat release) as a function of temperature and time. A Mettler Toledo DSC3+ was used in this work, which operates at a temperature range between −70° C. and 700° C. In a typical experiment, a samples is dehydrated by heating from 25° C. to 150° C. at a heating rate of 10° C./min. This is followed by a holding period at 150° C. for 45 minutes to ensure every part of the sample is dehydrated to the same extent. All the measurements were carried out by using approximately 5 mg of the sample under a flowing nitrogen atmosphere at a flow rate of 50 ml/min. The sample pans used in these experiments were 40 μl standard aluminium crucible with lid. The measured heat flow during the dehydration was used to quantify the heat storage capacity of the material. Additional experiments were performed at heating rates of 1° C./min, 2° C./min, 5° C./min and 10° C./min to investigate the influence of heating rate on the behaviour of the dehydration of salt hydrate materials.

### Simultaneous Thermal Analysis (STA)

STA is a combined DSC and thermogravimetric analysis (TGA) system for the measurement of heat flow and mass change as a function of temperature or time. A Netzsch STA 409 with a standard silicon carbide (SiC) furnace was used for the dehydration measurements. The measurements were done at the atmospheric pressure (1 atm) with approximately 10 mg of the sample under flowing nitrogen with a flow rate of 50 ml/min. A typical measurement involved increasing the temperature of the sample from 25° C. to 320° C., following by cooling the sample to 25° C., with both the heating and cooling at a rate of 5° C./min. The sample pans were a 40 μl standard aluminium crucible with lid. The measured heat flow and the mass change during the dehydration were used to understand the thermochemical process and to quantify the heat storage capacity of the materials.

Simultaneous Thermal Analysis (STA) with Humidity Control

A STA equipped with a humidity control unit has been used to study dehydration, hydration and cyclability of thermochemical energy storage materials and their composites. A low pressure LINSEIE STA apparatus was used in the work. Both the dehydration and hydration measurements were carried out at the atmospheric pressure by exposing approximately 20 mg sample under an air atmosphere at a flow rate of 100 ml/min. The use of air here was to ensure that the cycling tests were conducted under conditions similar practical applications. During hydration experiments, a platinum crucible of 70 μl without lids was used. For doing so, the sample was dehydrated first by heating from 25° C. to 150° C. at a heating rate of 1° C./min. This was followed by holding the sample at 150° C. for 60 minutes to ensure every part of the sample to be dehydrated. Finally, the sample was cooled down from 150° C. to 35° C. at a cooling rate of 2° C./min. The dehydrated sample was then held for 30 minutes before rehydration for 3-6 hours at a constant temperature of 35° C. with a relative humidity (RH) of 85%. The measured heat flow and the mass change during the dehydration and hydration processes were used to quantify the heat storage capacity of the material during the sorption cycle. Different rehydration temperatures at 25° C., 35° C., 45° C. and 55° C. were used to understand the effect of temperature on rehydration kinetics with an ultimate goal to find out the most suitable conditions for applications.

### Dynamic Vapour Sorption (DVS)

The DVS Advance from Surface Measurement Systems Ltd was used to investigate dynamic vapour/water desorption (dehydration) and adsorption (hydration) processes. The sample pans used were stainless steel of 200 μl, which can hold a sample size of 30-50 mg. In a typical dehydration process, the sample was heated from 25° C. to 135° C. at a heating rate of 1° C./min, followed by holding the sample at 135° C. for 60 minutes for complete dehydration. The sample was then cooled down from 135° C. to 35° C. at a cooling rate of 2° C./min, after which the sample was held at 35° C. for 30 minutes. The sample hydration was done at 35° C. with a RH of 85% for 12-16 hours until the equilibrium was reached. These measurements were carried out at atmospheric pressure by exposing the sample with 200 ml/min of nitrogen flow. The mass change as a function of time was collected during desorption (dehydration) and adsorption (hydration) processes.

The invention will be further exemplified by reference to the following non-limiting examples.

### Example 1—Dehydration of Pure MgSO₄·7H₂O

The kinetics of dehydration and hydration reactions are important for the application of MgSO₄·7H₂O as a TCM storage material. The kinetic parameters of these reactions can be used to help understand the reaction mechanisms and obtain optimal formulation of TCM composites.

In general, the dehydration reaction proceeds stepwise through a series of intermediate reactions involving the decomposition of one phase and the formation of a new one. Prior art studies have reported that the major dehydration step is completed at about 150° C., yielding MgSO₄·H₂O. However, a number of different intermediate phases such as MgSO₄·5H₂O, MgSO₄·3H₂O and MgSO₄·2H₂O, and a less well defined intermediate with 1.25-1.5 mol H₂O per mol MgSO₄ have also been reported. It has also been found that dehydration is subject to substantial variation strongly depending on the experimental conditions.

Referring now to FIG. 3, there is shown the XRD diffraction patterns 3 of raw MgSO₄·7H₂O at various temperature points between 25° C. and 300° C. during heating and then cooling to 25° C.

The XRD data suggest that dehydration of MgSO₄·7H₂O take place through three distinct stages demarcated by three temperature of 44° C., 80° C. and 276° C.:
Stage 1—The initial crystalline phase of MgSO₄·7H₂O (at 25° C.) is dehydrated upon heating to form a mixture of crystalline phases of MgSO₄·7H₂O and MgSO₄˜6H₂O at 28° C., and further heating result is in only MgSO₄·6H₂O crystalline phase at 44° C.
Stage 2—further heating leads to gradual dehydration of MgSO₄·6H₂O, forming MgSO₄·nH₂O at 80° C. No peaks in XRD patterns are observed between 80° C. and 276° C., indicating that MgSO₄·nH₂O is an amorphous phase.
Stage 3—Further heating to 300° C. gives the anhydrous MgSO₄ crystalline phase.

For the intermediate hydrated phases of MgSO₄·nH₂O, n could be between 5 and 0, e.g. 5, 4, 2.5, 2, 1 or 0.5. Differential Scanning Calorimetry (DSC) together with Simultaneous Thermal Analysis (STA) techniques were used to determine the intermediate phases. Since dehydration of MgSO₄·7H₂O requires certain time, and high heating rates can shift the dehydration peaks to a high temperature, there are needs to understand the influence of heating rate on the dehydration process. For doing so, analyses of the dehydration were performed with a DSC at heating rates of 1° C./min, 2° C./min, 5° C./min and 10° C./min under nitrogen to ensure no oxidation during the dehydration of epsomite.

Referring now to FIG. 4 there is shown a graph 4 of the heat flow of MgSO₄·7H₂O dehydration under various heating rates. A comparison of the heat flow data at these heating rates is shown in Table 1. The data clearly indicate the impact on the dehydration process. The highest heat flow with more detailed dehydration steps was obtained at the heating rate of 5° C./min, a commonly used DSC measurement condition for thermal energy storage materials. The measured enthalpy under this 5° C./min heating rate is also closest to the theoretical enthalpy of the pure TCM. The DSC and STA measurements were therefore carried out at this heating rate of 5° C./min in further study.

TABLE 1
DSC data to illustrate the heating rate effect
on heat flow of MgSO₄•7H₂O dehydration

| Heating rate | 10° C./min | 5° C./min | 2° C./min | 1° C./min |
|---|---|---|---|---|
| Heat flow (J/g) | −1267 | −1376 | −1270 | −1213 |
| Onset | 115.4° C. | 113.6° C. | 106.9° C. | 104.2° C. |
| Peak | 121.2° C. | 116.6° C. | 106.3° C. | 103.2° C. |
| Endset | 149.8° C. | 134.8° C. | 111.0° C. | 106.6° C. |

The hydrated intermediate phases (MgSO₄·nH₂O) and heat flow change during the steps were determined by using the mass change data of the dehydration of MgSO₄·7H₂O obtained with the STA and the heat flow data from of the DSC measurements

FIG. 5A shows the STA measurement data 5A for MgSO₄·7H₂O at 25-300° C., FIG. 5B shows the DSC data 5B measured over temperatures between 25 and 150° C. and FIG. 5C shows the DSC dehydration data 5C obtained over temperatures between 25 to 300° C. The steps of dehydration of MgSO₄·7H₂O are summarised in Table 2.

TABLE 2
Dehydration steps of MgSO₄•7H₂O by STA and DSC

| Tₒₙₛₑₜ | Enthalpy | Enthalpy | ΔTG | |
|---|---|---|---|---|
| (° C.) | (J/g) | (%) | (%) | Dehydration steps |
| 47.7 | 168 | 12 | 5.10 | MgSO₄•7H₂O(s) → MgSO₄•6 H₂O(s) + H₂O(g) |
| 67.7 | 378 | 27 | 15.04 | MgSO₄•6 H₂O(s) → MgSO₄•4 H₂O(s) + 2 H₂O(g) |
| 110.6 | 519 | 38 | 14.06 | MgSO₄•4 H₂O(s) → MgSO₄•2 H₂O(s) + 2 H₂O(g) |
| 140.8 | 166 | 12 | 3.17 | MgSO₄•2 H₂O(s) → MgSO₄•1.5H₂O(s) + 0.5 H₂O(g) |
| 149.7 | 145 | 11 | 3.48 | MgSO₄•H₂O(s) → MgSO₄•H₂O(s) + 0.5 H₂O(g) |
| <270 | — | — | 6.10 | MgSO₄•H₂O(s) → MgSO₄•0.2H₂O (s) + 0.8 H₂O(g) |
| 275 | — | — | 1.50 | MgSO₄•0.2 H₂O(s) → MgSO₄ (s) + 0.2 H₂O(g) |
| Total | 1376 | 100% | 40.87% (T ≤ 150° C.) | MgSO₄•7H₂O(s) → MgSO₄ (s) + 7H₂O(g) |
| | 2.3 | | 50.5% (T ≤ 300° C.) | |
| | GJ/m3 | | | |

Overall, the major dehydration steps of MgSO₄·7H₂O have occurred after a period of 45 minutes at 150° C. (see FIGS. 5A and 5B), yielding MgSO₄·H₂O. This temperature can be fairly easily achieved by for example using solar thermal collectors, waste heat, or renewable/off-peak electrical heating. The total enthalpy for MgSO₄·7H₂O dehydration is approximately 1376 J/g (determined using data shown in FIGS. 5A and 5B), giving an energy density of 2.30 GJ/m³ assuming that the density of MgSO₄·7H₂O is 1.68 g/cm³ and the sample is heated to 150° C. The complete dehydration of MgSO₄·7H₂O to give MgSO₄ occurred after heating to 300° C. under a dry nitrogen atmosphere (see FIGS. 5A and 5C). The thermogravimetric analysis (TG) results (FIG. 5A) indicate a total mass loss of 40.87% when the temperature of dehydration is about 150° C. This corresponds to a dehydration level of about 80%. Upon heating further to 300° C., the sample can be completely dehydrated to anhydrous magnesium sulphate. The measured total mass loss is found to be 50.5% (theoretical mass loss from heptahydrate to anhydrous magnesium sulphate is 51.1%). A small peak is observed at a temperature between 270° C. and 275° C., and the mass reaches a constant after 275° C. This indicates the loss of 0.2 H₂O at 275° C. to form anhydrous MgSO₄. These results are in agreement with the XRD analyses (FIG. 3). In summary, the combination of XRD, DSC and STA measurements has shown that the dehydration of MgSO₄·7H₂O has seven steps:
The first step has a mass loss of about 3.23% at 47.7° C. This corresponds to the dehydration of MgSO₄·7H₂O to MgSO₄·6H₂O. Note that the theoretical mass loss for this step is 7.3%, and the reason for the difference is that the initial material of the reaction had already partially dehydrated before the measurement. This is supported by the fact that the transition of MgSO₄·7H₂O to MgSO₄·6H₂O starts at the ambient temperature. Therefore, during the storage of the material before the measurement, around 56.2% of the initial MgSO₄·7H₂O powder had already been dehydrated into MgSO₄·6H₂O. This differs slightly from the XRD data, where the initial crystalline phase MgSO₄·7H₂O was found at 25° C. This can be explained by the fact that the XRD measurements were carried out using fresh samples, whereas the STA measurements were performed on the salt samples stored after 3-6 months.
The second step has a mass loss of 15.04% at 68.8° C., resulting in the intermediate phase of MgSO₄·4H₂O.
The third step has a mass loss of about 14.06% at 110° C., indicating a further loss of 2 mol H₂O per mol MgSO₄, leading to a residual water content of 2 mol H₂O in the sample.
The fourth step occurs at 140.8° C. with a mass loss of 3.17%, corresponding to the transition phase of MgSO₄·1.5 H₂O.
The fifth step occurs at 150° C. with a mass loss of 3.48%, resulting in a residual water content of 1 mol H₂O in the hydrate.
The sixth step takes place between 150° C. and 270° C. with an observed mass loss of 0.8 mol H₂O.
The final step gives a crystal phase of MgSO₄ with a small mass loss of 1.5% at 275° C.

### Example 2—Hydration of MgSO₄ Hydrates

Little systematic study has been reported on the hydration behaviour of MgSO₄ hydrates. Key factors affecting the hydration reaction are temperature and humidity. At a relative humidity above the equilibrium humidity of the hydration-dehydration reaction, the salt picks up water forming a higher hydrated state. Below the deliquescence humidity of the lower hydrated state, the hydration proceeds as a solid-state reaction, whilst above the deliquescence humidity, the mechanism of a complete solution takes place. Hydration of MgSO₄ hydrate needs more than 3 hours to reach the equilibrium state, and some studies have suggested that it may take between 12 to 20 hours, even up to 100 hours, to reach the final equilibrium. To understand the above, STA, DVS and in-situ Raman microscopic analyses were conducted.

Referring now to FIG. 6 there is shown a graph 6 of DVS data on the dehydration (desorption) and rehydration (adsorption) processes of MgSO₄·7H₂O. The DVS measurements were carried out using the same process as the STA measurements, with the exception of dehydration temperature and hydration time. The dehydration temperature was 135° C., which is the maximum safe operating temperature of the DVS preheat function (limited T<150° C.). The hydration process took 12 hours to ensure a sufficient isothermal time for MgSO₄ hydrate to reach equilibrium.

As shown in FIG. 6, the dehydration of MgSO₄·7H₂O at 135° C. in DVS indicates 40% of mass loss when heated from 25° C. to 135° C., representing 80% of the total water content (corresponding to 50.2% mass loss if heated to 150° C.). A similar mass loss was obtained by STA heated to 150° C. In the subsequent rehydration step, the MgSO₄ hydrate is seen to reach 80% of the initial mass in 3 hours under 85% RH at 35° C., and further 3-hour hydration leads to 92% of the initial mass. The data show that further 6 hours are needed to reach 97-100% of the initial mass. These results indicate that at least 6 hours are needed for the hydration process. A comparison between the dehydration and hydration data suggests that the MgSO₄ hydrate hydration (adsorption) process is considerably slower by ˜50% than the dehydration process.

Referring now to FIG. 7, there is provided a graph 7 showing the result of the mass change in dehydration/rehydration of MgSO₄·7H₂O at 25° C., 35° C., 45° C. and 55° C. The fastest hydration rate is seen to occur at 35° C., although the hydration has not reached the equilibrium after 6 hours. A total mass gain of 37.6% is observed, which represents 86% of the maximum water uptake. The hydration reaction rate of the MgSO₄ hydrate measured with STA is slower than that with DVS under the same experimental conditions. Although not wishing or intended to be bound by any theory we believe that this is because the sample holder of DVS is a fine-mesh pan, allowing the moist air to flow into the sample from the surrounding while the sample holder of STA only allows the sample-air contact from the top. An inspection of FIG. 7 also indicates that the mass loss curves during dehydration are almost identical, whereas the mass gain curves during hydration depend on hydration temperature. The data also indicate an optimal hydration condition of the MgSO₄ hydrate at 35° C. and RH 85% for 6 hours under the experimental conditions. This is consistent with the phase diagram of MgSO₄ hydrates.

### Example 3—Cyclablilty of MgSO₄·7H₂O

It is well-known that salt particles change volumes, size and morphology during dehydration/hydration cycles. These can have a profound impact on heat and mass transfer, leading to reduced kinetics and performance degradation. Little has been done on the influence of the thermal cycling on the behaviour of MgSO₄·7H₂O under a high number of cycles.

For addressing the above, 5 thermal cycles were performed initially, which showed that the rehydration rate of MgSO₄ hydrate increased significantly after the first cycle, and the mass gain of hydration reaction reached the expected equilibrium value in the fifth cycle by hydration for 3 hours. These initial experiments provided the data for setting the thermal cycling conditions for the subsequent cycling tests: dehydration for 3 hours, followed by hydration for 3 hours to complete one cycle, followed by repeating for a large number of cycles.

Referring now to FIG. 8, there is shown a graph 8 showing 30 cycles of dehydration and hydration. The heat flow was ˜1100 J/g during the dehydration of the first cycle at 150° C. The heat flow was only ˜600 J/g during rehydration of the first cycle at 35° C. with a RH of 85%, which was only 50% of the dehydration process. Such a result was confirmed by the TG analysis, showing the mass change reduced by 50%. In the second cycle, the heat flow of the dehydration reduced to ˜800 J/k, significantly lower than the first cycle; whereas the heat flow of hydration increased to ˜940 J/g.

From the second cycle, a significant increasing trend of heat flow and mass change for both dehydration and hydration processes were observed with increasing cycle number. This trend flattens after around 10 cycles, with the heat flow increased from ˜800 J/g (Cycle 2) to ˜1100 J/g (Cycle 10) for dehydration and from ˜940 J/g (Cycle 2) to ˜1200 J/g (Cycle 10) for hydration. This is supported by the TG data. The heat flow data were very close between dehydration and hydration reactions after 10 cycles, with the heat flow of hydration being 5-10% higher than that of dehydration in the same cycle, and the mass loss and mass gain being almost identical from the 11^{th} cycle onwards, which was approximately 92% of the original mass loss/mass gain. These results indicate that MgSO₄·7H₂O has a good cyclability for at least 30 cycles under these experimental conditions. These observations are encouraging, but are from a small amount of samples (e.g. 5 mg in DSC, 20 mg in STA). In order to gain an in-depth insight into the cyclability results of MgSO₄·7H₂O, Cycles 1, 5, 10, 20 and 30 denoted respectively by C1, C2, C5, C10, C20 and C30 were analysed.

Referring now to FIG. 9, there is shown a graph 9 showing a comparison of MgSO₄·7H₂O dehydration data from DSC analyses over different cycles. Two major peaks appeared in the dehydration process of the first cycle (C1). The first peak appeared at 20 minutes when the heating temperature was approximately 45° C., and the second peak occurred at 50 minutes. Only one peak (the second peak) was observed in the second and fifth cycles, although these cycles have identical peak profiles with a slight shift in peak positions. The peak positions and heat flows are distinctly different in C10, C20 and C30 compared with those in C5, C2 and C1 although the position of the peaks of C10, C20 and C30 are identical.

The morphology of the materials subjected to the thermal cycling was characterised by using SEM and the results are shown in FIGS. 10A to 10D for MgSO₄·7H₂O samples before and after dehydration at 150° C. and hydration at 35° C. and 85% RH in the STA, wherein FIG. 10A is before the start of the first cycle, FIG. 10B is after one cycle, FIG. 10C is after five cycles and FIG. 10D is after 30 cycles.

FIG. 10A shows SEM images showing the crystalline shaped morphology of MgSO₄·7H₂O 10, with a particle size of approximately 0.2-0.5 mm, along with fine cracks 11 distributed across the surface of samples. After the first cycle the volume of the particle 10′ was slightly bigger than the raw material 10 (FIG. 10B compared to FIG. 10A) and some coarse cracks 11′ were observed across the sample surface, indicating that the salt particle expanded during the cycle. These indicate that after the first cycle, the thin cracks were created in crystal 10′, forming a form that releases water molecules more easily. This may explain why the heat flow of hydration increased significantly from second cycle. FIG. 10C shows that, after 5 cycles, particle 10″ appears to have swelled and developed large cracks, leading to some paths of air/moisture flow 11″. The enlarged image of the particle 10″ in FIG. 10C suggests the particle is an agglomerate of small crystals. A different morphology was observed, as shown in FIG. 10D, after 30 cycles. The particle 10′″ becomes bigger in size (>0.5 mm) with a much large air/water flow channels 11′″. These morphological and size changes during the thermal cycling could explain, at least in a qualitative manner, the increased reaction enthalpy in the first 3-5 cycles during which as cracks and hence more air/moisture flow channels and/or reaction surface area are created. Note that the significant changes to the morphology of the salt particles, as shown in FIG. 10D, appear to indicate structural stability of pure salt. Such changes have a small effect on the reaction heat over 30 cycles mainly due to small amount of samples (e.g. 5 mg in DSC or 20 mg in STA) so no substantial heat and mass transfer effects are expected. An increase in the sample amount is likely to affect the kinetics due to heat and mass transfer given the significant morphology and hence structural changes. This is evidenced by the little progress so far in advancing the practical applications of the MgSO₄·7H₂O.

### Example 4—Hydration/Dehydration of MgSO₄·7H₂O Composites of Different Formulations

In order to determine the optimal composite formulation, DSC measurements were carried out on two types of composites (MgSO₄·7H₂O/MgO and MgSO₄·7H₂O/vermiculite) made according to Experiment Section 2 above.

Composites with different percentages of MgSO₄·7H₂O salt were made using MgO or vermiculite as a host material, forming two series of MgSO₄·7H₂O composite samples.

These samples were cycled in a high temperature humidity chamber, and analysed with the DVS. Three repeats were performed for each of the measurements.

### Example 4A

Heat flow of MgSO₄·7H₂O composites made with 0.25 mm MgO or vermiculite, containing 10, 20, 30, 40, 50 and 60 wt % of MgSO₄·7H₂O before and after one cycle of dehydration/hydration (FIG. 11).

### Example 4B

60 wt % of MgSO₄·7H₂O/vermiculite composites, made with different vermiculite particle sizes of 0.08 mm, 0.125 mm, 0.25 mm, 0.5 mm and 1 mm (FIG. 12).

### Example 4C

MgSO₄·7H₂O/vermiculite composites containing 50 and 60 wt % MgSO₄·7H₂O made with different vermiculite particle sizes of 0.08 mm, 0.125 mm, 0.5 mm and 1 mm in a compacted pellet/module form and a non-compacted powder form (FIG. 13).

The surface analyses data of the host materials determined by mercury porosimetry and nitrogen physisorption BET are summarised in Table 3. The total porosities (ϕ), bulk densities (P_{bulk}) and the median pore diameters (Dₘ) were determined with the mercury intrusion technique. The BET data listed are for an upper pore diameter limit of 13 nm, including the median diameters (D₁₃), the total surface areas (SSA) and the total porosity (ϕ₁₃) of pores with diameters<13 nm. Specific pore volumes (Vₚ) are calculated from total porosity and density data by Vₚ=(ϕ+ϕ₁₃)/P_{bulk}.

TABLE 3
Host materials data obtained by mercury intrusion porosimetry (ϕ, P_{bulk} Dₘ) and nitrogen
physisorption (D₁₃ₘ, SSA, ϕ₁₃).

| Host matrices | ϕ (%) | Pbulk (g/cm³) | Dₘ (um) | D₁₃ₘ (nm) | SSA (m²/g) | ϕ₁₃ (%) | Vp (cm³/g) |
|---|---|---|---|---|---|---|---|
| Vermiculite 1 mm | 92.8 | 0.1968 | 18.25 | 6.82 | 4.1733 | 6.7 | 5.06 |
| Vermiculite 0.5 mm | 87.4 | 0.3465 | 15.62 | 7.52 | 4.9594 | 1.7 | 2.57 |
| Vermiculite 0.25 mm | 86.9 | 0.3619 | 10.78 | 7.64 | 4.6761 | 2.5 | 2.41 |
| Vermiculite 0.12 mm | 83.1 | 0.4494 | 8.31 | 8.58 | 6.0811 | 2.9 | 1.91 |
| Vermiculite 0.08 mm | 76.1 | 0.6516 | 2.64 | 7.64 | 10.1612 | 2.8 | 1.21 |
| MgO | 81.3 | 0.6415 | 0.7 | 5.02 | 7.006 | 7.3 | 1.37 |

There is a considerable contribution of small pores in 1 mm vermiculite (ϕ₁₃=6.7%) with median pore diameter of ˜6.8 nm. The same holds for the MgO particles. Small pores with median pore diameter in the size range of 7.52 and 8.58 nm exist in vermiculite with the other particle sizes, but the contribution of the small pores to the total porosity of these particle sizes is small. The bulk density and surface area of vermiculite increase with decreasing particle sizes, whereas the total porosity, the specific pore volume and Dₘ of vermiculite all decease with decreasing particle size.

### Example 4A—Single Cycle Hydration/Dehydration

Referring now to FIG. 11, there is shown a graph 11 of the DSC results of the dehydration heat flow of raw MgSO₄·7H₂O/vermiculite and MgSO₄·7H₂O/MgO composites (i.e. prior to the first cycle) and the composites after one cycle of dehydration/hydration.

The heat flow is seen to increase significantly with increasing percentage of MgSO₄·7H₂O in the composites, with compositions above 40 wt % MgSO₄·7H₂O having heat flows in excess of 600 J/g. The dehydration heat flow of the composite containing 60% MgSO₄·7H₂O ranges from 658 to 749 J/g. FIG. 11 also indicates that two series of the MgSO₄·7H₂O composites are stable after one cycle, and the cycled composites give a heat flow some ˜10-30% higher in comparison with that of the non-cycled sample.

### Example 4B—Vermiculite Size Effect

Referring now to FIG. 12, there is shown a graph 12 showing the effect of the particle size of vermiculite on dehydration of MgSO₄·7H₂O/vermiculite composites.

The DSC results show that the dehydration heat flow of the composite containing 60% MgSO₄·7H₂O ranges from 658 to 758 J/g where the particle size of vermiculite changes from 0.08 mm to 1 mm (heat enthalpy of raw vermiculite is approximately 150 J/g). These data indicate relatively small effect of particle size of vermiculite on the dehydration of the MgSO₄·7H₂O composites, although the heat flow appears slightly higher when the particle size of vermiculite is between 0.5 mm and 1 mm.

### Example 4C—Effect of the Form of Composite MgSO₄·7H₂O Hydrates

Referring now to FIG. 13, there is shown a graph 13 illustrating the dehydration heat flow of MgSO₄·7H₂O/vermiculite composites in compacted pellet and powder forms. The pellet form of composites is compacted and is expected to have a higher effective thermal conductivity but interparticle mass transfer may be affected; whereas the powder form of composites has a lower effective thermal conductivity but the mass transfer is less restricted. These suggest that the difference in the enthalpy of two forms of composites be likely to be small under the conditions of the set of experiments due to balance between heat transfer and mass transfer effects, which is indeed reflected by the data shown in FIG. 13.

Although the heat flow data for the composites containing 50% and 60% MgSO₄·7H₂O in the pellet form has a small difference from that in the powder form during dehydration, the pellet form of MgSO₄·7H₂O composites show no or little variation between the three repeated measurements and is therefore regarded as more stable than the powder form counterpart.

### Example 5—Hydration/Dehydration of MgSO₄ Hydrate Composites

DVS measurements were performed on the MgSO₄·7H₂O/MgO and MgSO₄·7H₂O/vermiculite composites containing 60% of the salt hydrate. Both dehydration and hydration were carried out using the same DVS procedure as the pure MgSO₄·7H₂O for comparison purpose. The results are shown in FIGS. 14 and 15.

Referring now to FIG. 14, there is shown a graph 14 showing the dehydration (desorption) and hydration (adsorption) data for MgSO₄·7H₂O/MgO composite measured by DVS. Heating (dehydration) of the 60 wt % MgSO₄·7H₂O/MgO composite pellet gave 23% of mass loss when heated from 25° C. to 135° C., which is 76% of the total water content (30.2% in total in the hydrate). The hydration of the MgSO₄ hydrate composite was under 85% RH at 35° C., a 2-hour hydration process achieved 100% of the initial mass. A comparison of these data with that for the pure MgSO₄ hydrate (FIG. 6) indicates that the use of the host material improves significantly the hydration reaction rate.

Referring now to FIG. 15, there is shown a graph 15 showing the DVS dehydration (desorption) and hydration (adsorption) data for the MgSO₄·7H₂O/vermiculite (0.25 mm) composite. Similar observations can be made as that shown in FIG. 14 for the MgSO₄·7H₂O/MgO composite.

Referring to now to FIG. 16, there is shown a graph 16 comparing the DVS dehydration and hydration data of MgSO₄·7H₂O composites with different vermiculite particle sizes over two cycles. Only small difference is seen in the kinetics of the rehydration, consistent with the data shown in FIG. 12.

The above results suggest that the MgO and vermiculite not only provide the structure to hold the salt hydrates, but also improve significantly the sorption kinetics due to the accelerated rehydration process (˜2 hours vs 6-12 hours for the pure MgSO₄·7H₂O). To ensure sufficient isothermal time for MgSO₄ hydrate composites to reach the equilibrium, 3 hours hydration time was used in subsequent experiments on the composites.

### Example 6—Cyclability of MgSO₄·7H₂O Composites

Both MgSO₄·7H₂O/MgO and MgSO₄·7H₂O/vermiculite composites containing 60% of salt hydrate have demonstrated promising results in terms of energy density and rehydration kinetics. These data are for either a single dehydration-hydration cycle or a limited number of cycles (up to 5 cycles). Multi-cycle stability of the composites is crucial for practical applications. In order to understand this, 35 cycles of dehydration/hydration were carried out, and the influence of thermal properties during the cycles were analysed.

### Example 6A—Cyclability of MgSO₄·7H₂O/MgO Composites

Referring now to FIG. 17 there is shown a graph 17 providing the results of cycling 60 wt % of MgSO₄·7H₂O/MgO. A reaction heat of 500 J/g was measured for 60% of the salt) in the first cycle. The reaction heat increased slightly to approximately 550 J/g after three cycles. From the 4^{th} cycle, a significant decreasing trend of heat flow occurred to both dehydration and hydration processes with increasing number of cycles. The trend flattened after 16 cycles, where the heat flow stabilised at ˜250 J/g (˜50% of the first cycle). This is also reflected by and is in agreement with the decrease in the mass change from 100% to 50%. No further reduction in the heat flow and mass change was observed after 17^{th} cycle. These result indicate that the 60 wt % MgSO₄·7H₂O/MgO composite has degraded in the first 16 cycles in terms of energy density, but stablises thereafter at an energy density of ˜250 J/g. Although not ideal for long term energy storage, this energy density remains highly competitive compared with sensible and latent heat storage given only 60% of salt is in the composite. Given the low cost of the raw material, this still has good potential for short and medium term energy storage applications.

### Example 6B—Cyclability of Vermiculite Composites

FIG. 18 shows a graph 18 providing the cycling results for the 60 wt % MgSO₄·7H₂O/0.5 mm vermiculite composite.

The graph demonstrates an excellent cyclability of the MgSO₄/vermiculite composite over the 35 cycles, with the heat flow of hydration ranging between 612 and 827 J/g, and that of dehydration between 639 and 774 J/g. The mass changes during hydration and dehydration vary within a small range, consistent with the changes in hydration/dehydration heat flows. Note that the data are for 60% of salt loading in the composite. If one takes the sorption heat of vercumlite as 150 kJ/kg, the contribution of the host material to the total sorption heat is 60 kJ/kg, and that of MgSO₄ salt is 690 kJ/kg, which would be equivalent to 1150 kJ/kg of pure MgSO₄ salt.

The DSC analyses on the cycles 1, 10, 20, 30 and 35 (C1, C10, C20, C30 and C35) of MgSO₄·7H₂O/vermiculite dehydration/hydration were subsequently performed. FIG. 19 shows a graph 19 displaying a comparison of the C1, C10, C20, C30 and C35 cycles of the 60 wt % MgSO₄·7H₂O/0.5 mm vermiculite composite. Identical heat enthalpy profiles in both dehydration and hydration processes were obtained for each of the cycles (C1, C10, C20, C30 and C35), demonstrated excellent stability of the composite.

FIG. 20 shows images of the 60% wt MgSO₄·7H₂O/MgO (FIG. 20A) and 60% wt MgSO₄·7H₂O/vermiculite (FIG. 20B) before and after the STA cycling test. These images show macroscopically that both MgSO₄·7H₂O composites remain structurally stable after cycles of dehydration and hydration although there are changes to the surface morphologies.

FIGS. 21A to 21E show respectively microscopic SEM images of the samples of raw MgO 210, raw MgSO₄·7H₂O 211, raw MgSO₄·7H₂O/MgO composite 212, and the MgSO₄·7H₂O/MgO composite after five cycles 212′ and the MgSO₄·7H₂O/MgO composite after 35 cycles 212″.

FIG. 21A shows agglomerated sub-micron/nano sized spherical MgO particles 210, with a diameter of 0.5-0.7 μm, the size of the agglomerate being 5-10 μm. FIG. 21B shows the morphology of MgSO₄·7H₂O 211, which can have a crystal size of approximately 0.2-0.5 mm, along with fine cracks 213 distributed across the surface of the sample. FIG. 21C shows the morphology of the composite 212 containing sub-micron/nanosized spherical MgO with MgSO₄·7H₂O milled to be smaller than the MgO aggregates. FIG. 21D shows the composite sample 212″ with cracks and channels 214 developed for air/moisture flow. FIG. 21E shows that the composite sample 212″ displays a completely different and interesting morphology. This morphology shows egg-shaped units with diameters of 1-3 μm, and fine cracks 214′ across the surface of the egg-shaped units, which may provide an explanation to the stablised heat flow after 16^{th} cycles (FIG. 17). These results appear to show that the salt particles are mainly in the interparticle voids of the thermochemical material.

The SEM images shown in FIGS. 22A to 22D are the samples of vermiculite 220, raw MgSO₄·7H₂O/60%/vermiculite composite 221, the composite after three cycles 221′ and the composite after 35 cycles 221″, respectively.

The raw vermiculite sample 220 (0.5 mm particle size) consists of layers in the form of stacked platelets (FIG. 22A). FIG. 22B shows morphology of the composite 221 with fine cracks 222 on the surface of the samples. FIG. 22C shows that the composite sample 221′ has become more porous with a fractures, making the structure take up and release water with a lower resistance than the original structure because more surface area and channels are available. FIG. 22D shows the composite sample 221″ having a higher extent of porous morphology with a loosely agglomerated net-like structure containing large pores and channels for air/moisture 223 in-between, wherein the pore diameter ranges from 2 to 10 μm. These results appear to indicate the presence of salt in both the interparticle and intraparticle voids.

### Example 7—Cycling of MgSO₄·7H₂O/Vermiculite Composite Modules/Pellets in a Humidity Chamber

MgSO₄·7H₂O/vermiculite composites have been shown to have excellent cyclability over cycles (FIGS. 18, 19). These cycling tests were carried out with very small (˜20 mg) samples in an STA instrument under a well controlled conditions. There is a need to understand if the conclusion also holds for larger sized samples made under different compact conditions undergoing a larger number of cycles in a less well-controlled environment.

For doing so, studies were done first to make composite compacted pellets under different compact pressures of 10 MPa, 20 MPa, 30 MPa and 40 MPa. A loading speed of 20 mm/min was used for the compression with a holding time of 1 min before unloading. The composite pellets were 13 mm in diameter with each having a mass of 1.5 g. These pellets were then placed in a high temperature humidity chamber and cycled for 100 times under similar conditions as cycling in the STA. Characterisation of the composite pellets were then done after different number of cycles.

FIGS. 23A to 23D show images of the 60 wt % MgSO₄·7H₂O/0.5 mm vermiculite pellets after 0 cycle, 10 cycles, 30 cycles and 100 cycles, wherein sample 230 was made at 10 MPa, sample 231 at 20 MPa, sample 232 at 30 MPa and sample 233 at 40 MPa.

Changes to the morphologies and integrity of the pellets are apparent with the increasing number of thermal cycles. The pellets are seen to expand slightly after 10 cycles (FIG. 23B), after 30 cycles, the pellets' structure appeared to be loose and weak with some powders coming off from the original structure (FIG. 23C) and after 100 cycles most of the pellets became powdery and the structure weakened, with the original pellet shape/structure lost (FIG. 23D).

XRT analyses were performed on the samples cycled for 30 times with samples made under various compaction pressures (10, 20, 30 and 40 MPa) to investigate the morphology and the change to the pellets structure, the results are shown in FIGS. 24A to 24C, wherein FIG. 24A are 2D images of the raw 60 wt % MgSO₄·7H₂O/vermiculite composite pellets, FIG. 24B are 2D images of the composites after 30 cycles and FIG. 24C are 3D images of the composites after 30 cycles at 10, 20, 30 and 40 MPa.

As shown in FIG. 24A, the dark areas 240 of the 2D images of the raw composites are a pore or air pathway. Smaller pores and fewer air pathways were observed with the higher compaction pressures. FIG. 24B shows that the porous structure of the cycled samples have cracks 241 developed between the outer layer and inner layer of the pellets. The pellet under 40 MPa has the largest cracks and has lost its original round shape. The 3D images of these cycled samples (FIG. 24C) show that the pellet with 20 MPa maintains relatively round shape than the pellets with other compaction pressures. Overall, all cycled pellets developed cracks.

The pellets expanded from the top with cracks where contact with air/moisture is quicker and easier than other parts of the pellets.

The ring-shaped cracks may be related to the loading/unloading speed during manufacturing. To understand these effects, the loading speed was reduced from 20 mm/min to 10 mm/min, and the holding time was increased from 1 minute to 3 minutes. The compression pressures investigated were 15 MPa, 20 MPa, 25 MPa and 30 MPa. FIG. 25 shows the images of raw pellets 250 made with the new process, and pellets undergoing 16 cycles 251 and 30 cycles 252. XRT analyses were also done on the raw pellets and that after 30 cycles in the humidity chamber, with the results shown in FIGS. 26A and 26B, respectively.

As shown in FIG. 25, the pellets (250, 251 and 252) made with new manufacturing process show significantly better structural integrity than that made at the higher loading rate and the shorter holding time. For pellets cycled for 30 times, although cracks can be observed from the surface, the structural integrity remain. This is also supported by the XRT analyses as shown in FIG. 26A and FIG. 26B.

FIG. 26A shows 2D images of the raw 60 wt % MgSO₄·7H₂O/vermiculite pellets made with compression pressures of 15, 20, 25 and 30 MPa using the new procedure described above. They are similar to the 2D images of raw pellets shown in FIG. 24.

FIG. 26B shows 2D images of the pellets undergoing 30 cycles. There are four groups of images taken from the pellets made with different pressures as indicated. Each of the groups of the images consists of a 3D image of the cylindrical pellet (middle left) and three 2D images taken from three cross-sections at different vertical positions of the cylindrical pellets (the top images from top part of the pellets; middle right images from middle part of pellets; and bottom images from bottom part of the pellets). The cracks 260 between the outer layer and inner layer of the cylindrical wall are seen to have developed for all pellets produced at the top part of the pellets likely due to easy contact with air/water vapour. Small cracks are also seen in the middle and bottom parts of the pellets. These images also indicate that the structure integrity remains over 30 cycles despite the formation of cracks.

XRD analyses with an ambient stage were also performed to investigate the chemical stability and compatibility of the composites undergoing different cycles, whereas DSC measurements were done on the composites to understand the effect of thermal cycling on the reaction enthalpy. The results are shown in FIG. 27 and FIG. 28, respectively.

FIG. 27 shows a graph 27 of the XRD results of 60 wt % MgSO₄·7H₂O/vermiculite pellets after 0 (raw), 10, 30, 40, 60, 80 and 100 cycles in a humidity chamber. Identical crystalline phases were obtained for the samples in all cycles, indicating no variations in crystallinity and phases of MgSO₄·7H₂O/vermiculite composite after 100 cycles, exhibiting excellent chemical stability and compatibility of the components of the composite.

FIG. 28 shows a graphs 28 of the DSC results of 60 wt % MgSO₄·7H₂O/vermiculite pellets after 0 (raw), 10, 30, 40, 50, 80, and 100 cycles. Despite fluctuations in the measured heat flow in DSC over different cycles, no significant dedradation is observed, indicating very good cyclability.

### Example 8—the Addition of Binder

To further enhance the structure integrity and mechanical strength of the composites, the addition of a small amount of binder was investigated. In this study, the lower compression speed was used to make the pellets with the longer pressure holding time as described in Example 7. Polyvinylpyrrolidone (polyvidone PVP), a water-soluble polymer, was selected due to good adhesion property, high melting temperature (a 150° C.) and hygroscopic nature of PVP. Aqueous solutions of PVP were made (10% in H₂O). The effect of PVP concentrations of 0.5, 1, 2 and 3 wt % was studied with respect to the composite weight (i.e. the wt % PVP as a proportion of the TCM). The pellets were placed in the high temperature humidity chamber and were cycled for 80 times. FIG. 29 shows photos of the pellets after 0 (raw), 20, 40 and 80 cycles. Little change can be seen to the pellets with different binder concentrations after 20 cycles. Slight expansion of pellets is seen after 40 cycles and further expansion occurs after 80 cycles but the structure integrity remains high. An inspection of these photos indicates the pellet with 20 MPa and 2% binder concentration gives the best structural integrity.

The MgSO₄·7H₂O/vermiculite composite pellets with 2 wt % binder was also subject to DSC analyses to understand if the use of binder affects the dehydration and hydration kinetics. FIG. 30 shows a graph 30 of the reaction heat as a function of cycle numbers for the 60 wt % MgSO₄·7H₂O/vermiculite composite with 2% binder (PVP). A good cyclability of MgSO₄/vermiculite composite with 2% binder can be seen over 30 cycles, in consistent with the observation shown in graph 29. The heat flow is seen to be ˜900±200 J/g over 30 cycles, consistent with the mass change. Note that the data are for 58.8% of salt loading in the composite with 39.2% host material and 2% binder. If one takes the sorption heat of vercumlite as 150 kJ/kg, the contribution of the host material to the total sorption heat is 58.8 kJ/kg, and that of MgSO₄ salt is ˜840 kJ/kg, which would be very close to the theoretical energy density of pure MgSO₄ salt.

The results detailed above demonstrate clear advantages of the composite TCM pellets including high energy density, high chemical stability and compatibility, good reaction kinetics, high extent of structure integrity, and high cyclability.

Although the above data demonstrate the effects with hydrated magnesium sulphate other potential CTMs could be used in its place. Moreover, the host material need not be limited to vermiculite and MgO and may be other inorganic species. Further, the binder need not be limited to PVP but may be other binders such as starches, alginates, casein, cellulose adhesives, for example hydroxypropyl methylcellulose (HPMC), polyvinyl acetate (PVA), polyacrylic acid and the like.

Moreover, although the above description refers to a compaction manufacturing process, it is also possible to fabricate TCMs using, for example, a granulation or an extrusion process.

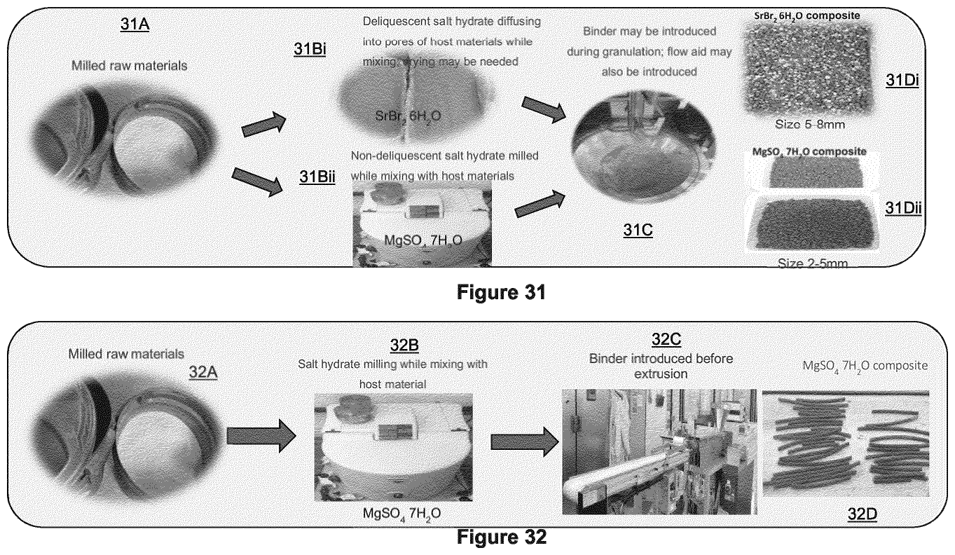

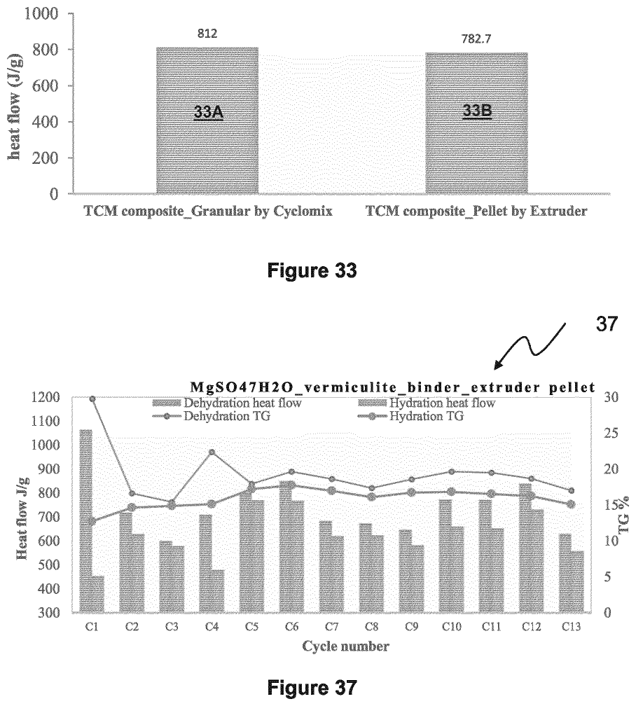

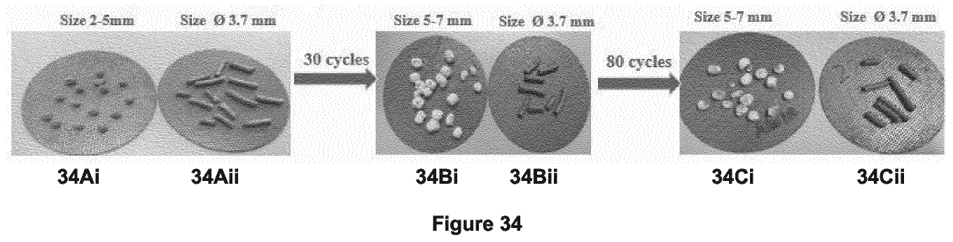

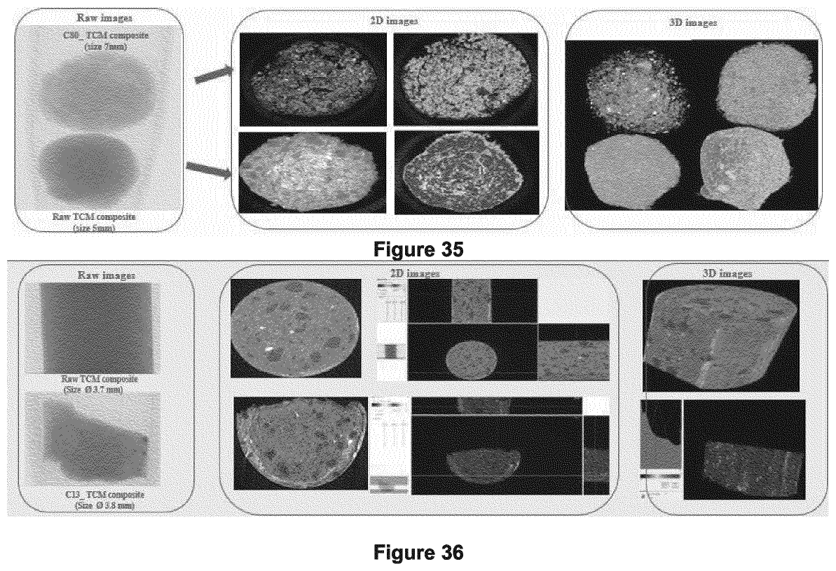

The invention will now be further described, by way of example only, and with reference to the accompanying drawings in which:
FIG. 31 is a flow chart illustrating a batch process of manufacturing the granule form of composite thermochemical material;
FIG. 32 is a flow chart illustrating a continuous process of manufacturing the extruded form of composite thermochemical material;
FIG. 33 is a graph showing a comparison of the measured reaction enthalpy of composite TCM fabricated with the granulation and extrusion methods;
FIG. 34 provides images to demonstrate the shape stability of the granulated and extruded composite TCM;
FIG. 35 provides images to show the structure of the granule form of composite TCM;
FIG. 36 provides images to show the structure of the extruded form of composite TCM; and
FIG. 37 is a graph of the dehydration/hydration of extruded sample after different thermal cycles.

Referring now to FIG. 31 there is shown an exemplary process for the formation of granulated TCM for both deliquescent materials (e.g. SrBr₂·6H₂O) and non-deliquescent materials (e.g. MgSO₄·7H₂O).

In each case, a first step or stage 31A comprises milling the host material (e.g. vermiculite or MgO) to an optimal size range (say between 0.08 mm and 1 mm) and mixing the hosting material with the salt hydrate of up to 80 wt %, say from 20 to 80 wt %, for example 40 to 70 wt %. In an embodiment 60 wt % of salt hydrate is used.

In a second step or stage for deliquescent materials 31Bi, the mixing may take place under deliquescent conditions (i.e. at a relative humidity which is sufficient to cause the material to dilequesce) so that the TCM could diffuse into the interparticle and intraparticle voids of the host material. The resulting mixture is fed to the third step 3 or stage. If the mixture has a poor flowability, a drying step may be deployed to increase the flowability of the mixture, and a flow aid may also be added in this stage.

In a second step or stage for non-deliquescent materials 31Bii, the salt hydrate is milled to micron size e.g. 1-100 μm, while mixing with host material in a media mill, for example, a ball mill where milling ball size is determined empirically using a method reported in http://www.minproc.pwr.wroc.pl/journal/pdf/ppmp48-2.329-339.pdf. This stage may also include the addition of a flow aid.

In both cases, a third step or stage 31C may comprise mixing the materials from the second stage with up to 5 wt % of a binder (e.g. a binder selected from polyvinylpyrrolidone (polyvidone PVP), starches, alginates, casein, cellulose adhesives, for example hydroxypropyl methylcellulose (HPMC), polyvinyl acetate (PVA), polyacrylic acid and mixtures of the same). The binder is presented as a solution.

In a fourth step or stage 31D, the material mixture from stage 31C is granulated using a high shear mixer, for example a Cyclomix® high shear mixer available from Hosokawa Micron BV of Doetinchem, Netherlands. The granulation conditions are such as to form densified granules of, preferably substantially round-shaped granules with a size of say 2-8 mm. In exemplary conditions (room temperature, 2% binder addition) the deliquescent materials may be made into granules of sizes 5-8 mm (as shown in 31Di) and the non-deliquescent materials may be formed into granules of 2-5 mm sizes (as shown in 31Dii) Referring now to FIG. 32 there is shown an exemplary process for the formation of extruded composite TCMs.

In a first step or stage 32A the hosting material is ground in the same manner as in 31A above.

In a second step or stage 32B the salt hydrate is milled to micron size e.g. 1-100 μm, while mixing with the host material in a mill, for example a ball mill in the same manner as in 31Bi or 31Bii.

In a third step or stage 32C binder is added to the ground mixture from the second stage 32B (e.g. binder at up to 5 wt %) and the mixed material is then extruded.

The material is extruded through a die (a thick steel disc with an opening) to form composite TCM, for example with an outside diameter of 2-20 mm for this type of applications. As shown at 32D the extruded TCM is MgSO₄·7H₂O/MgO (60/35 wt %) with 5 wt % PVP binder and an outside diameter of ca. 4 mm.

Referring to FIG. 33, the measured reaction enthalpy (energy density) of the granulated composite TCM (33A) and the extruded composite TCM (33B) (each comprising MgSO₄·7H₂O/MgO (60/35 wt %) with 5 wt % PVP binder) was assessed by STA as detailed in Section 3 above (Materials Characterisation).

The energy densities shown in FIG. 33 are respectively 812 and 783 J/g, corresponding to 0.92 GJ/m³ or 255 kWh/m³ (granulated composite TCM) and 0.89 GJ/m³ or 246 kWh/m³ (extruded composite TCM), demonstrating the feasibility of manufacturing of composite TCMs using both the methods.

As will be appreciated, the extrustion route may be particularly beneficial as a continuous process route can oftentimes represent production advantages over batch processes.

The invention will be further described with reference to the following Examples.

### Example 9A—Thermal Cycling of Granulated Composite TCMs

The granulated composite MgSO₄/vermiculite TCM made in accordance with the process described above (FIG. 31) was subject to thermal cycling in a high temperature humidity chamber under the same conditions as that for FIG. 30.

FIG. 34 shows the granulated material at 0 cycles (34Ai), 30 cycles (34Bi) and 80 cycles (34Ci). The granulated composite TCM was observed to increase in size up to 30 cycles and then remains substantially constant in the subsequent cycles, demonstrating good structural integrity of the composite.

FIG. 35 shows a comparison between a TCM granule at 0 cycles (bottom images) and 80 cycles (top images). At 0 cycles the granule had a nominal size of 5 mm whereas at 80 cycles this had increased to 7 mm (a 40% increase in size or ca. 275% increase in volume). However, the 2D images and 3D images, taken using respectively the SEM and XRT techniques, showed little evidence of cracking or structural weakness, which support the as structural integrity of the granulated composite TCM after 80 cycles.

### Example 9B—Thermal Cycling of Extruded TCMs

FIG. 36 shows a comparison between an extruded TCM at 0 cycles (bottom images) and 13 cycles (top images). At 0 cycles the extrudate had a nominal size of 3.7 mm whereas at 13 cycles this had increased to 3.8 mm (a 3% increase in size). The size/volume change after 80 cycles remains small evidenced by comparing FIG. 34Aii, FIG. 34Bii and FIG. 34Cii). The 2D (SEM) images and 3D (XRT) images showed little evidence of cracking or structural weakness, demonstrating the structural integrity of the extrudates.

Referring to FIG. 37, there is showing the DSC measurements of the reaction heat as a function of cycle numbers for the extrudate of 60 wt % MgSO₄·7H₂O/vermiculite/MgO composite with 5% binder (PVP). A good cyclability of the extrudate can be seen over 13 cycles. The heat flow is seen to be varying, ˜800±200 J/g, over 13 cycles, consistent with the mass change of the thermal cycles.

The above results show that hydrated or hydratable salt materials provided within the formed TCM at proportions in excess of 40 wt %, preferably above 50 wt %, for example above 55 wt % have desirable mechanical stability and thermal cycling performance. The hydrated or hydratable salt materials are found in the interparticle voids and within the porous structure of the inorganic host material. In more porous, or plate-like or stratified host material such as vermiculite, the proportion of hydrated or hydratable salt materials in intraparticle voids is likely to be higher than with less porous material such as MgO. The provision of a binder, for example at 2 wt %, can help to consolidate the TCM without compromising performance.

The results detailed above clearly demonstrate advantages of the pelleted, tableted, extruded and granulated composite TCMs including high energy density, high chemical stability and compatibility, good reaction kinetics, high extent of structure integrity, high cyclability.

1. A method of forming a composite thermochemical material, the method comprising providing an inorganic host material and providing a hydrated or hydratable inorganic salt, mixing the inorganic host material and hydrated or hydratable inorganic salt in relative low humidity conditions to form a dr powder mix, allowing or causing at least a portion of the hydrated or hydratable inorganic salt to enter pores and/or void spaces of the inorganic host material and forming the dry powder mix into a shaped body.

2. The method according to claim 1 comprising providing the inorganic host material as particles.

3. The method according to claim 1, comprising providing the inorganic host material in a size range of 0.01 to 10 mm, for example from any one of 0.02, 0.03, 0.4 or 0.05 to any one of 10.0, 9.0, 8.0, 7.0, 6.0, 5.0, 4.0, 3.0, 2.0, 1.0 mm.

4. The method according to claim 1, comprising providing the hydrated or hydratable inorganic salt as particles.

5. The method according to claim 1, comprising providing the hydrated or hydratable inorganic salt in, or causing the hydrated or hydratable inorganic salt to have, a size range of 0.01 μm to 100 μm.

6. The method according to claim 1, comprising providing the hydrated or hydratable inorganic salt at weight proportions of 20 to 80 wt % and/or providing the inorganic host material at weight proportions of 80 to 20 wt %, preferably providing the hydrated or hydratable salt in excess (wt %) of the inorganic host material.

7. The method according to claim 1, comprising providing the hydrated or hydratable salt in mass excess compared to the inorganic host material.

8. The method according to claim 1, comprising providing a binder.

9. The method according to claim 1, comprising providing a binder to the mix and, preferably, subsequently mixing.

10. The method according to claim 1, comprising providing a binder in amounts of up to 5 wt %.

11. The method according to claim 1, wherein the mixing, preferably under shear, causes or allows at least a portion of the hydrated or hydratable inorganic salt to enter pores of the inorganic host material.

12. The method according to claim 1, comprising adding a flow aid, for example adding a flow aid in up to 5 wt %.

13. (canceled)

14. The method according to claim 1, comprising forming the mix into a shaped body by one or more of pelletising, tabletting, granulating or extruding the mix.

15. The method according to claim 1, comprising providing the shaped body with a maximum transverse dimension in the range of of from 1 to 600 mm.

16. A composite thermochemical material, the thermochemical material comprising a dry powder mixture of particles of inorganic host material and a hydrated or hydratable inorganic salt, wherein at least a portion of the hydrated or hydratable salt is located within pores and/or void spaces of the inorganic host material and the hydrated or hydratable salt is present in excess of 40 wt %.

17. The composite thermochemical material according to claim 16, wherein the hydrated or hydratable inorganic salt is selected from MgSO₄·7H₂O, K₂CO₃·H₂O, CaSO₄·2H₂O or SrBr₂·6H₂O, Al₂(SO₄)₃·6H₂O, CuSO₄·5H₂O, Li₂SO₄·H₂O, Ca(OH)₂, Mg(OH)₂·H₂O, Fe(OH)₂, Na₂S·5H₂O, CaCl₂)·6H₂O, MgCl₂·6H₂O or mixtures thereof.

18. The composite thermochemical material according to claim 16, wherein the hydrated or hydratable inorganic salt has a theoretical volumetric energy density of or above 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1 or 3.2 GJ/m³.

19. The composite thermochemical material according to claim 16, wherein the hydrated or hydratable inorganic salt is present in percentages above 45 wt %, say above 50, 55, 60, 65, 70, 75, or 80 wt % and/or wherein the inorganic host material in percentage of less than 60 wt %, e.g. less than 55, 50, 45, 40, 35, 30, 25, 20 wt %.

20. The composite thermochemical material according to claim 16, wherein the inorganic host material is selected from vermiculite, zeolites, MgO, diatomite, clay, silica gel, porous glass, attapulgite, graphite, activated carbon, graphite and/or combinations thereof.

21. The composite thermochemical material according to claim 16, wherein the particles of inorganic host material have a diameter in excess of 0.02 mm, for example in the size range of 0.02, 0.03, 0.4 or 0.05 to 10.0 9.0, 8.0, 7.0, 6.0, 5.0, 4.0, 3.0, 2.0, 1.0 mm, preferably in the range 0.05 mm to 1 mm.

22. The composite thermochemical material according to claim 16, further comprising a binder and wherein the binder may be selected from polyvinylpyrrolidone (polyvidone PVP), starches, alginates, casein, cellulose adhesives, for example hydroxypropyl methylcellulose (HPMC), polyvinyl acetate (PVA), polyacrylic acid and mixtures of the same.

23. The composite thermochemical material according to claim 22, wherein the binder is in a range of up to 5 wt %, for example between 0.25 to 5 wt %, e.g. 0.5 to 3 wt %.

24. The composite thermochemical material according to claim 16, further comprising a flow aid, for example a flow aid present in the amount of 0.01% to 5.0%.

25. The composite thermochemical material according to claim 16 provided in a pellet, tablet, extruded or granular form.
